(19) United States
(12) Patent Application Publication
(10) Pub. No.: US 2025/0316203 A1
(43) Pub. Date: Oct. 9, 2025

(54) DISPLAY DEVICE AND METHOD OF DRIVING THE SAME, AND ELECTRONIC DEVICE

(71) Applicant: Samsung Display Co., LTD., Yongin-si (KR)

(72) Inventors: Se Hyun LEE, Yongin-si (KR); Kwi Hyun KIM, Yongin-si (KR); Dong Woo KIM, Yongin-si (KR); Jung Hwan HWANG, Yongin-si (KR)

(21) Appl. No.: 18/988,669

(22) Filed: Dec. 19, 2024

(30) Foreign Application Priority Data
Apr. 8, 2024 (KR) 10-2024-0047213

(51) Int. Cl. G09G 3/20

(52) U.S. Cl. CPC G09G 3/2074; G09G 3/2011; G09G 2300/0819; G09G 2320/0238

(57) ABSTRACT

A display device includes: sub-pixels including a first circuit unit configured to control a supply period of a driving current correspondingly to a first data signal, and a second circuit unit configured to supply the driving current to a light emitting element correspondingly to a second data signal; and a display unit partitioned into j (j is a natural number of 2 or more) blocks including two or more of the sub-pixels, wherein the sub-pixels included in different blocks are configured to emit light at different times.

### CROSS-REFERENCE TO RELATED APPLICATION

The present application claims priority to and the benefit of Korean Patent Application No. 10-2024-0047213, filed on Apr. 8, 2024, the entire disclosure of which is herein incorporated by reference.

### BACKGROUND

### 1. Field

Aspects of some embodiments of the present disclosure relate to a display device and a method of driving the same, and electronic device.

### 2. Description of the Related Art

As information technology develops, importance of a display device, which is a connection medium between a user and information, is emerging. In response to this, a use of a display device such as a liquid crystal display device and an organic light emitting display device is increasing.

The display device may include sub-pixels and may display an image (e.g., a set or predetermined image) using the sub-pixels. When the sub-pixels emit light simultaneously, a method that may relatively improve display quality of a display device is required.

The above information disclosed in this Background section is only for enhancement of understanding of the background and therefore the information discussed in this Background section does not necessarily constitute prior art.

### SUMMARY

Aspects of some embodiments of the present disclosure include a display device and a method of driving the same that may relatively improve display quality by dividing a display unit into a plurality of blocks and controlling an emission time in a block unit.

Aspects of some embodiments of the present disclosure include a display device and a method of driving the same in which emission times of sub-pixels included in each of blocks do not overlap, thereby minimizing or reducing a voltage drop (IR-drop) of driving power.

According to some embodiments of the disclosure, a display device includes sub-pixels including a first circuit unit for controlling a supply period of a driving current correspondingly to a first data signal, and a second circuit unit for supplying the driving current to a light emitting element correspondingly to a second data signal, and a display unit partitioned into j (j is a natural number of 2 or more) blocks including two or more of the sub-pixels, and the sub-pixels included in different blocks emit light at different times.

According to some embodiments, the sub-pixels are divided into an initialization period, a first data signal writing period, a second data signal writing period, and an emission period, and are driven, and the emission period includes j sub-periods.

According to some embodiments, sub-pixels included in a first block among the j blocks emit light in a first sub-period, and sub-pixels included in a j-th block emit light in a j-th sub-period that does not overlap the first sub-period.

According to some embodiments, a voltage of the first data signal is set correspondingly to a grayscale to be expressed.

According to some embodiments, the second data signal of the same voltage is supplied to the sub-pixels.

According to some embodiments, the sub-pixels include a first sub-pixel that emits light of a first color, a second sub-pixel that emits light of a second color, and a third sub-pixel that emits light of a third color, and a voltage of the second data signal is different in the first sub-pixel, the second sub-pixel, and the third sub-pixel.

According to some embodiments, the first circuit unit includes a first transistor having a gate electrode connected to a first node, a first electrode connected to a second node, and a second electrode connected to a third node, a second transistor connected between a data line and the second node, and having a gate electrode connected to a first scan line, a third transistor connected between the first node and the third node and having a gate electrode connected to the first scan line, a fourth transistor connected between the first node and a fourth power line, and having a gate electrode connected to a first initialization line, a fifth transistor connected between a first power line and the second node, and having a gate electrode connected to an emission control line, a sixth transistor connected between the third node and a fourth node, and having a gate electrode connected to the emission control line, and a first capacitor connected between a sweep line and the first node.

According to some embodiments, the first transistor, the fifth transistor, and the sixth transistor are P-type transistors, and the second transistor, the third transistor, and the fourth transistor are N-type transistors.

According to some embodiments, the first transistor has an auxiliary gate electrode connected to the first power line, each of the second transistor and the third transistor has an auxiliary gate electrode connected to the first scan line, and the fourth transistor has an auxiliary gate electrode connected to the first initialization line.

According to some embodiments, the second circuit unit includes a seventh transistor having a gate electrode connected to the fourth node, a first electrode connected to a fifth node, and a second electrode connected to a sixth node, an eighth transistor connected between the data line and the fifth node, and having a gate electrode connected to a second scan line, a ninth transistor connected between the fourth node and the sixth node, and having a gate electrode connected to the second scan line, a tenth transistor connected between the fourth node and the fourth power line, and having a gate electrode connected to a second initialization line, an eleventh transistor connected between a second power line and the fifth node, and having a gate electrode connected to the emission control line, a twelfth transistor connected between the sixth node and a first electrode of the light emitting element, and having a gate electrode connected to the emission control line, a thirteenth transistor connected between the first electrode of the light emitting element and a fifth power line, and having a gate electrode connected to a third initialization line, the light emitting element connected between the twelfth transistor and a third power line, and a second capacitor connected between the second power line and the fourth node.

According to some embodiments, the seventh transistor, the eleventh transistor, the twelfth transistor, and the thirteenth transistor are P-type transistors, and the eighth transistor, the ninth transistor, and the tenth transistor are N-type transistors.

According to some embodiments, the seventh transistor has an auxiliary gate electrode connected to the second power line, each of the eighth transistor and the ninth transistor has an auxiliary gate electrode connected to the second scan line, and the tenth transistor has an auxiliary gate electrode connected to the second initialization line.

According to some embodiments, the second scan line, the first initialization line, and the second initialization line are commonly connected to the sub-pixels.

According to some embodiments, the first scan line is configured of a plurality of first scan lines, and the plurality of first scan lines are connected to the sub-pixels in a horizontal line unit.

According to some embodiments, the emission control line is configured of a plurality of emission control lines positioned in each block, the sub-pixels positioned in different blocks are electrically connected to different emission control lines, the sweep line is configured of a plurality of sweep lines positioned in each block, the sub-pixels positioned in different blocks are electrically connected to different sweep lines, the third initialization line is configured of a plurality of third initialization lines positioned in each block, and the sub-pixels positioned in different blocks are electrically connected to different third initialization lines.

According to some embodiments, the display device further includes a first scan driver for supplying a first scan signal to the first scan line, an emission driver for supplying an emission control signal to the emission control line, a sweep driver for supplying a reference voltage and a sweep signal to the sweep line, a third initialization driver for supplying a third initialization signal to the third initialization line, and a timing controller for controlling the first scan driver, the emission driver, the sweep driver, and the third initialization driver.

According to some embodiments, the timing controller supplies a second scan signal to the second scan line, a first initialization signal to the first initialization line, and a second initialization signal to the second initialization line.

According to some embodiments, the display device further includes a second scan driver for supplying a second scan signal to the second scan line, a first initialization driver for supplying a first initialization signal to the first initialization line, and a second initialization driver for supplying a second initialization signal to the second initialization line.

According to some embodiments of the present disclosure, a display device includes a display unit partitioned into a plurality of blocks including two or more sub-pixels, and sub-pixels included in different blocks emit light at different times during one frame period.

According to some embodiments of the present disclosure, a method of driving a display device includes initializing sub-pixels included in a first block and a second block, supplying a first data signal corresponding to an emission time while sequentially selecting the sub-pixels included in the first block and the second block, simultaneously supplying a second data signal corresponding to a driving current to the sub-pixels included in the first block and the second block, emitting light by the sub-pixels included in the first block during a first period of one frame period, and emitting light by the sub-pixels included in the second block during a second period that does not overlap the first period of the one frame period.

According to some embodiments of the disclosure, an electronic device including a processor to provide input image data; a display device to display an image based on the input image data. The display device includes sub-pixels including a first circuit unit for controlling a supply period of a driving current correspondingly to a first data signal, and a second circuit unit for supplying the driving current to a light emitting element correspondingly to a second data signal, and a display unit partitioned into j (j is a natural number of 2 or more) blocks including two or more of the sub-pixels, and the sub-pixels included in different blocks emit light at different times.

The characteristics of embodiments according to the present disclosure are not limited to the characteristics described above, and other characteristics which are not described will be more clearly understood by those skilled in the art from the following description.

In a display device and a method of driving the same according to some embodiments of the present disclosure, sub-pixels may emit light in a block unit, thereby minimizing or reducing a voltage drop (IR-drop) of driving power.

However, the characteristics of embodiments according to the present disclosure are not limited to the above-described characteristics, and may be variously extended within a range that does not deviate from the spirit and scope of embodiments according to the present disclosure.

### BRIEF DESCRIPTION OF THE DRAWINGS

The above and other characteristics of embodiments according to the present disclosure will become more apparent by describing in further detail aspects of some embodiments thereof with reference to the accompanying drawings, in which:

FIG. 1 is a circuit diagram illustrating a sub-pixel according to some embodiments of the present disclosure;

FIG. 2 is a diagram illustrating a sub-pixel according to some embodiments of the present disclosure;

FIG. 3 is a waveform diagram illustrating aspects of a method of driving the sub-pixel shown in FIGS. 1 and 2;

FIG. 4 is a waveform diagram illustrating aspects of a method of driving the sub-pixel shown in FIGS. 1 and 2;

FIG. 5 is a block diagram illustrating a display device according to some embodiments of the present disclosure;

FIG. 6 is a block diagram illustrating a display device according to some embodiments of the present disclosure;

FIG. 7 is a waveform diagram illustrating aspects of a method of driving the display device shown in FIGS. 5 and 6;

FIGS. 8A to 9B are diagrams illustrating an emission area of a display unit;

FIG. 10 is a block diagram illustrating a display device according to some embodiments of the present disclosure;

FIG. 11 is a waveform diagram illustrating aspects of a method of driving the display device shown in FIG. 10;

FIGS. 12A to 15B are diagrams illustrating the emission area of the display unit; and

FIGS. 16 to 19 are perspective views illustrating application examples of a display device according to some embodiments of the present disclosure.

FIG. 20 is a schematic block diagram illustrating an electronic device including a display device in accordance with an embodiment.

### DETAILED DESCRIPTION

Hereinafter, various embodiments of the disclosure will be described in detail with reference to the accompanying drawings so that those skilled in the art may easily carry out the disclosure. The disclosure may be implemented in various different forms and is not limited to the embodiments described herein.

In order to more clearly describe aspects of embodiments according to the present disclosure, certain components or parts that are not necessary to enable a person having ordinary skill in the art to make, use, and understand embodiments according to the present disclosure may be omitted, and the same or similar elements are denoted by the same reference numerals throughout the specification. Therefore, the above-described reference numerals may be used in other drawings.

In addition, an expression “is the same” in the description may mean “is substantially the same”. That is, the expression “is the same” may be the same enough for those of ordinary skill to understand that it is the same. Other expressions may also be expressions in which “substantially” is omitted.

Aspects of some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the inventive concept. In addition, in some embodiments, the block, unit and/or module may be physically combined into more complex blocks, units, and/or modules without departing from the scope of the inventive concept.

A term “connection” between two configurations may mean that both of an electrical connection and a physical connection are used inclusively, but is not limited thereto. For example, “connection” used based on a circuit diagram may mean an electrical connection, and “connection” used based on a cross-sectional view and a plan view may mean a physical connection.

Although a first, a second, and the like are used to describe various components, these components are not limited by these terms. These terms are used only to distinguish one component from another component. Therefore, a first component described below may be a second component within the technical spirit of the disclosure. The singular expression includes the plural expression unless the context clearly dictates otherwise.

Meanwhile, the disclosure is not limited to the embodiments disclosed below, and may be modified in various forms and may be implemented. In addition, each of the embodiments disclosed below may be implemented alone or in combination with at least one of other embodiments.

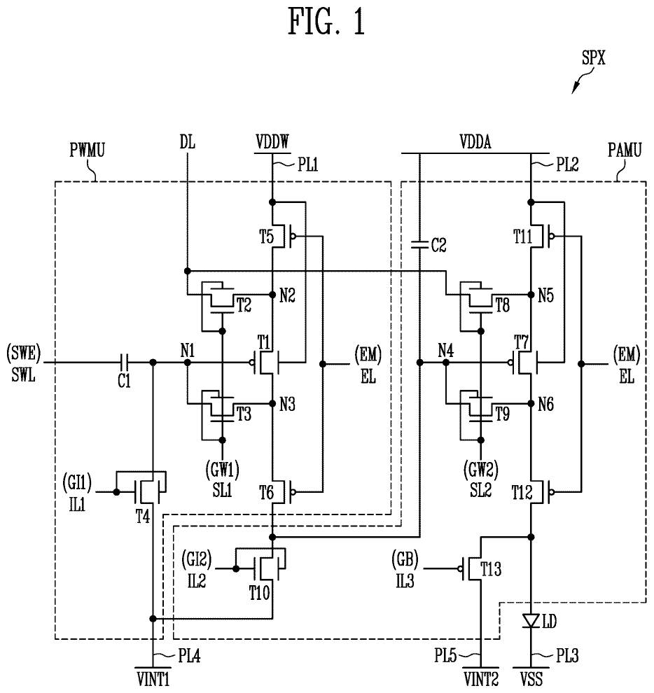

FIG. 1 is a circuit diagram illustrating a sub-pixel according to some embodiments of the present disclosure. Although FIG. 1 illustrates various components in a sub-pixel according to some embodiments, embodiments according to the present disclosure are not limited thereto, and according to some embodiments, the sub-pixel may include additional components or fewer components without departing from the spirit and scope of embodiments according to the present disclosure.

Referring to FIG. 1, the sub-pixel SPX according to some embodiments of the present disclosure may include a first circuit unit PWMU, a second circuit unit PAMU, and a light emitting element LD. The sub-pixel SPX may emit first light, second light, or third light. Correspondingly to this, the light emitting element LD included in the sub-pixel SPX may generate light of first light, second light, or third light.

The first light may be light of a red wavelength band, the second light may be light of a green wavelength band, and the third light may be light of a blue wavelength band. The red wavelength band may be a wavelength band in a range of 600 nanometers (nm) to 750 nm (or approximately 600 nm to 750 nm), the green wavelength band may be a wavelength band in a range of 480 nm to 560 nm (or approximately 480 nm to 560 nm), and the blue wavelength band may be a wavelength band in a range of 370 nm to 460 nm (or approximately 370 nm to 460 nm), but embodiments of the present disclosure are not limited thereto.

The light emitting element LD may be connected between the second circuit unit PAMU and a third power line PL3. For example, a first electrode (or an anode electrode) of the light emitting element LD may be connected to the second circuit unit PAMU, and a second electrode (or a cathode electrode) may be connected to the third power line PL3. The light emitting element LD may emit light with a luminance (e.g., a set or predetermined luminance) correspondingly to a driving current supplied from the second circuit unit PAMU.

The light emitting element LD may be an inorganic light emitting element including an inorganic semiconductor. For example, the light emitting element LD may be a flip chip type micro light emitting diode element. According to some embodiments, the light emitting element LD may be configured of an organic light emitting diode, a quantum dot light emitting diode, or the like. In addition, although only one light emitting element LD is shown in FIG. 1, the light emitting element LD may be configured of a plurality of ultra-small light emitting elements. For example, a plurality of ultra-small light emitting elements may be connected in series, parallel, or series-parallel.

The first circuit unit PWMU may control a supply period of the driving current supplied to the light emitting element LD based on a first data signal received from a data line DL. The first data signal may be set to different voltages correspondingly to a grayscale to be expressed.

The first circuit unit PWMU may be a pulse width modulation (PWM) circuit unit. When the supply period of the driving current is decreased, because an emission period of the sub-pixel SPX is decreased, a luminance of the sub-pixel SPX may be decreased. When the supply period of the driving current is increased, because the emission period of the sub-pixel SPX is increased, the luminance of the sub-pixel SPX may be increased.

The second circuit unit PAMU may supply the driving current to the light emitting element LD based on a second data signal received from the data line DL. The second circuit unit PAMU may be a pulse amplitude modulation (PAM) circuit unit. A voltage value of the second data signal may be set so that a second driving transistor T7 included in the second circuit unit PAMU may be driven in a linear region. In this case, the second driving transistor T7 may supply a constant current as the driving current to the light emitting element LD.

Meanwhile, the sub-pixel SPX may be divided into a first sub-pixel, a second sub-pixel, and a third sub-pixel according to a type of emitted light. For example, the first sub-pixel may emit the first light, the second sub-pixel may emit the second light, and the third sub-pixel may emit the third light.

According to some embodiments, the second data signal may have the same voltage regardless of a type of sub-pixel SPX. According to some embodiments, the second data signal may have different voltages correspondingly to the type of sub-pixel SPX. For example, the second data signals supplied to each of the first sub-pixel, the second sub-pixel, and the third sub-pixel may have different voltages.

The first circuit unit PWMU may include a first transistor T1, a second transistor T2, a third transistor T3, a fourth transistor T4, a fifth transistor T5, a sixth transistor T6, and a first capacitor C1.

A first electrode of the first transistor T1 (or a first driving transistor) is connected to a second node N2, and a second electrode is connected to a third node N3. In addition, a gate electrode of the first transistor T1 is connected to a first node N1. The first transistor T1 may control a current amount flowing from a first power line PL1 to which first power VDDW is supplied to a fourth node N4 correspondingly to a voltage of the first node N1. The first power VDDW may be set to a sufficiently high voltage so that a current may flow from the first power line PL1 to the fourth node N4.

The first transistor T1 may further include an auxiliary gate electrode, and the auxiliary gate electrode may be connected to the first power line PL1. The first transistor T1 may be set as a P-type transistor, and when the auxiliary gate electrode is connected to the first power line PL1, a driving current may be stabilized.

A first electrode of the second transistor T2 is connected to the data line DL, and a second electrode is connected to the second node N2. In addition, a gate electrode of the second transistor T2 is connected to a first scan line SL1. The second transistor T2 may be turned on when an enable first scan signal GW1 is supplied to the first scan line SL1 to electrically connect the data line DL and the second node N2. The enable first scan signal GW1 may have a voltage at which the second transistor T2 may be turned on, for example, a high voltage.

The second transistor T2 may further include an auxiliary gate electrode, and the auxiliary gate electrode may be connected to the first scan line SL1. The second transistor T2 may be set as an N-type transistor, and a current efficiency may be relatively improved when the auxiliary gate electrode is connected to the first scan line SL1.

A first electrode of the third transistor T3 is connected to the third node N3, and a second electrode is connected to the first node N1. In addition, a gate electrode of the third transistor T3 is connected to the first scan line SL1. The third transistor T3 is turned on when the enable first scan signal GW1 is supplied to the first scan line SL1 to electrically connect the first node N1 and the third node N3. When the third transistor T3 is turned on, the first transistor T1 may be connected in a diode form.

The third transistor T3 may further include an auxiliary gate electrode, and the auxiliary gate electrode may be connected to the first scan line SL1. The third transistor T3 may be set as an N-type transistor, and a current efficiency may be relatively improved when the auxiliary gate electrode is connected to the first scan line SL1.

A first electrode of the fourth transistor T4 is connected to the first node N1, and a second electrode is connected to a fourth power line PL4. In addition, a gate electrode of the fourth transistor T4 is connected to a first initialization line IL1. The fourth transistor T4 may be turned on when an enable first initialization signal GI1 is supplied to the first initialization line IL1 to electrically connect the fourth power line PL4 and the first node N1. A voltage of the first initialization power VINT1 may be supplied to the fourth power line PL4, and the first initialization power VINT1 may be set to a voltage lower than the first data signal. The enable first initialization signal GI1 may have a voltage at which the fourth transistor T4 may be turned on, for example, a high voltage.

The fourth transistor T4 may further include an auxiliary gate electrode, and the auxiliary gate electrode may be connected to the first initialization line IL1. The fourth transistor T4 may be set as an N-type transistor, and a current efficiency may be relatively improved when the auxiliary gate electrode is connected to the first initialization line IL1.

A first electrode of the fifth transistor T5 is connected to the first power line PL1, and a second electrode is connected to the second node N2. In addition, a gate electrode of the fifth transistor T5 is connected to an emission control line EL. The fifth transistor T5 may be turned off when a disable emission control signal EM is supplied to the emission control line EL, and may be turned on when an enable emission control signal EM is supplied. The disable emission control signal EM may have a voltage at which the fifth transistor T5 may be turned off, for example, a high voltage. The enable emission control signal EM may have a voltage at which the fifth transistor T5 may be turned on, for example, a low voltage.

A first electrode of the sixth transistor T6 is connected to the third node N3, and a second electrode is connected to the fourth node N4. In addition, a gate electrode of the sixth transistor T6 is connected to the emission control line EL. The sixth transistor T6 may be turned off when the disable emission control signal EM is supplied to the emission control line EL, and may be turned on when the enable emission control signal EM is supplied.

A first electrode of the first capacitor C1 is connected to a sweep line SWL, and a second electrode is connected to the first node N1. The first capacitor C1 may be driven as a coupling capacitor and may transmit a voltage change of the sweep line SWL to the first node N1.

The second circuit unit PAMU may include a seventh transistor T7, an eighth transistor T8, a ninth transistor T9, a tenth transistor T10, an eleventh transistor T11, a twelfth transistor T12, a thirteenth transistor T13 and a second capacitor C2.

A first electrode of the seventh transistor T7 (or a second driving transistor) is connected to a fifth node N5, and a second electrode is connected to a sixth node N6. In addition, a gate electrode of the seventh transistor T7 is connected to the fourth node N4. The seventh transistor T7 may control a current amount of a driving current supplied to the light emitting element LD from a second power line PL2 to which second power VDDA is supplied correspondingly to a voltage of the fourth node N4. At this time, the driving current may be supplied from the second power line PL2 to the third power line PL3 to which third power VSS is supplied via the eleventh transistor T11, the seventh transistor T7, the twelfth transistor T12, and the light emitting element LD. A second electrode of the light emitting element LD may be connected to the third power line PL3 to which the third power VSS is supplied, and the third power VSS may be set to a voltage lower than that of the second power VDDA.

The seventh transistor T7 may further include an auxiliary gate electrode, and the auxiliary gate electrode may be connected to the second power line PL2. The seventh transistor T7 may be set as a P-type transistor, and when the auxiliary gate electrode is connected to the second power line PL2, the driving current may be stabilized.

A first electrode of the eighth transistor T8 is connected to the data line DL, and a second electrode is connected to a fifth node N5. In addition, a gate electrode of the eighth transistor T8 is connected to a second scan line SL2. The eighth transistor T8 may be turned on when an enable second scan signal GW2 is supplied to the second scan line SL2 to electrically connect the data line DL and the fifth node N5. The enable second scan signal GW2 may have a voltage at which the eighth transistor T8 may be turned on, for example, a high voltage.

The eighth transistor T8 may further include an auxiliary gate electrode, and the auxiliary gate electrode may be connected to the second scan line SL2. The eighth transistor T8 may be set as an N-type transistor, and a current efficiency may be relatively improved when the auxiliary gate electrode is connected to the second scan line SL2.

A first electrode of the ninth transistor T9 is connected to the sixth node N6, and a second electrode is connected to the fourth node N4. In addition, a gate electrode of the ninth transistor T9 is connected to the second scan line SL2. The ninth transistor T9 may be turned on when the enable second scan signal GW2 is supplied to the second scan line SL2 to electrically connect the fourth node N4 and the sixth node N6. When the ninth transistor T9 is turned on, the seventh transistor T7 may be connected in a diode form.

The ninth transistor T9 may further include an auxiliary gate electrode, and the auxiliary gate electrode may be connected to the second scan line SL2. The ninth transistor T9 may be set as an N-type transistor, and a current efficiency may be relatively improved when the auxiliary gate electrode is connected to the second scan line SL2.

A first electrode of the tenth transistor T10 is connected to the fourth node N4, and a second electrode is connected to the fourth power line PL4. In addition, a gate electrode of the tenth transistor T10 is connected to a second initialization line IL2. The tenth transistor T10 may be turned on when an enable second initialization signal GI2 is supplied to the second initialization line IL2 to electrically connect the fourth power line PL4 and the fourth node N4. The voltage of the first initialization power VINT1 may be supplied to the fourth power line PL4, and the first initialization power VINT1 may be set to a voltage lower than that of the second data signal. The enable second initialization signal GI2 may have a voltage at which the tenth transistor T10 may be turned on, for example, a high voltage.

The tenth transistor T10 may further include an auxiliary gate electrode, and the auxiliary gate electrode may be connected to the second initialization line IL2. The tenth transistor T10 may be set as an N-type transistor, and a current efficiency may be relatively improved when the auxiliary gate electrode is connected to the second initialization line IL2.

A first electrode of the eleventh transistor T11 is connected to the second power line PL2, and a second electrode is connected to the fifth node N5. In addition, a gate electrode of the eleventh transistor T11 is connected to the emission control line EL. The eleventh transistor T11 may be turned off when the disable emission control signal EM is supplied to the emission control line EL and turned on when the enable emission control signal EM is supplied.

A first electrode of the twelfth transistor T12 is connected to the sixth node N6, and a second electrode is connected to the first electrode of the light emitting element LD. In addition, a gate electrode of the twelfth transistor T12 is connected to the emission control line EL. The twelfth transistor T12 may be turned off when the disable emission control signal EM is supplied to the emission control line EL and turned on when the enable emission control signal EM is supplied.

A first electrode of the thirteenth transistor T13 is connected to the first electrode of the light emitting element LD, and a second electrode is connected to a fifth power line PL5. In addition, a gate electrode of the thirteenth transistor T13 is connected to a third initialization line IL3. The thirteenth transistor T13 may be turned on when an enable third initialization signal GB is supplied to the third initialization line IL3 to electrically connect the fifth power line PL5 and the first electrode of the light emitting element LD. A voltage of second initialization power VINT2 may be supplied to the fifth power line PL5, and the voltage of the second initialization power VINT2 may be set to discharge a parasitic capacitor of the light emitting element LD.

When the parasitic capacitor of the light emitting element LD is discharged, a black expression ability of the sub-pixel SPX may be relatively improved. When the fifth power line PL5 and the first electrode of the light emitting element LD are electrically connected, the light emitting element LD may be set to a non-emission state. The enable third initialization signal GB may have a voltage at which the thirteenth transistor T13 may be turned on, for example, a low voltage.

The second capacitor C2 is connected between the second power line PL2 and the fourth node N4. The second capacitor C2 may store a voltage corresponding to the second data signal.

According to some embodiments, the first transistor T1, the fifth transistor T5, the sixth transistor T6, the seventh transistor T7, the eleventh transistor T11, the twelfth transistor T12, and the thirteenth transistor T13 may be formed of a polysilicon semiconductor transistor. For example, the first transistor T1, the fifth transistor T5, the sixth transistor T6, the seventh transistor T7, the eleventh transistor T11, the twelfth transistor T12, and the thirteenth transistor T13 may include a polysilicon semiconductor layer formed through a low temperature poly-silicon (LTPS) process as an active layer (channel). In addition, the first transistor T1, the fifth transistor T5, the sixth transistor T6, the seventh transistor T7, the eleventh transistor T11, the twelfth transistor T12, and the thirteenth transistor T13 may be P-type transistors (for example, PMOS). Accordingly, a gate-on voltage that turns on the first transistor T1, the fifth transistor T5, the sixth transistor T6, the seventh transistor T7, the eleventh transistor T11, the twelfth transistor T12, and the thirteenth transistor T13 may be a logic low level. Because the polysilicon semiconductor transistor may have an advantage of a fast response speed, the polysilicon semiconductor transistor may be applied to a switching element that requires fast switching.

The second transistor T2, the third transistor T3, the fourth transistor T4, the eighth transistor T8, the ninth transistor T9, and the tenth transistor T10 may be formed of oxide semiconductor transistors. For example, the second transistor T2, the third transistor T3, the fourth transistor T4, the eighth transistor T8, the ninth transistor T9, and the tenth transistor T10 may be N-type oxide semiconductor transistors (for example, NMOS transistors) and may include an oxide semiconductor layer as an active layer. Accordingly, a gate-on voltage that turns on the second transistor T2, the third transistor T3, the fourth transistor T4, the eighth transistor T8, the ninth transistor T9, and the tenth transistor T10 may be a logic high level.

The oxide semiconductor transistor may be processed at a low temperature and has charge mobility lower than that of the polysilicon semiconductor transistor. That is, the oxide semiconductor transistor has an excellent off-current characteristic. Therefore, when the second transistor T2, the third transistor T3, the fourth transistor T4, the eighth transistor T8, the ninth transistor T9, and the tenth transistor T10 are formed of oxide semiconductor transistors, a leakage current due to low-frequency driving may be minimized or reduced, and thus display quality may be relatively improved.

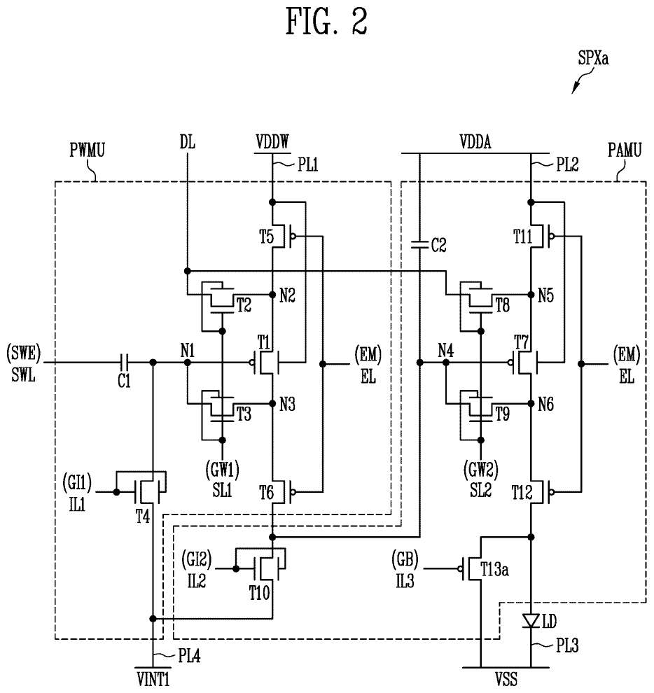

FIG. 2 is a diagram illustrating a sub-pixel according to some embodiments of the present disclosure. Although FIG. 2 illustrates various components in a sub-pixel according to some embodiments, embodiments according to the present disclosure are not limited thereto, and according to some embodiments, the sub-pixel may include additional components or fewer components without departing from the spirit and scope of embodiments according to the present disclosure. When describing FIG. 2, the same reference numerals are assigned to the same configurations as those of FIG. 1, and some overlapping description may be omitted.

Referring to FIG. 2, the sub-pixel SPXa according to some embodiments of the present disclosure may include the first circuit unit PWMU, the second circuit unit PAMU, and the light emitting element LD.

A first electrode of a thirteenth transistor T13a included in the second circuit unit PAMU is connected to the first electrode of the light emitting element LD, and the second electrode is connected to the third power line PL3. For example, the fifth power line PL5 shown in FIG. 1 may be replaced with the third power line PL3 (or may be set to the same power line), and thus the fifth power line PL5 may be deleted.

A gate electrode of the thirteenth transistor T13a is connected to the third initialization line IL3. The thirteenth transistor T13a may be turned on when the third enable initialization signal GB is supplied to the third initialization line IL3 to electrically connect the third power line PL3 and the first electrode of the light emitting element LD.

When the third power line PL3 and the first electrode of the light emitting element LD are electrically connected, a parasitic capacitor of the light emitting element LD may be discharged, and thus a black expression ability of the sub-pixel SPXa may be relatively improved. When the third power line PL3 and the first electrode of the light emitting element LD are electrically connected, the light emitting element LD may be set to a non-emission state.

Meanwhile, according to some embodiments of the present disclosure, a structure of the sub-pixels SPX and SPXa is not limited by FIGS. 1 and 2. For example, when the sub-pixels SPX and SPXa are connected to the sweep line SWL and express a grayscale correspondingly to a voltage change of the sweep line SWL, a circuit structure of the sub-pixel may be variously changed.

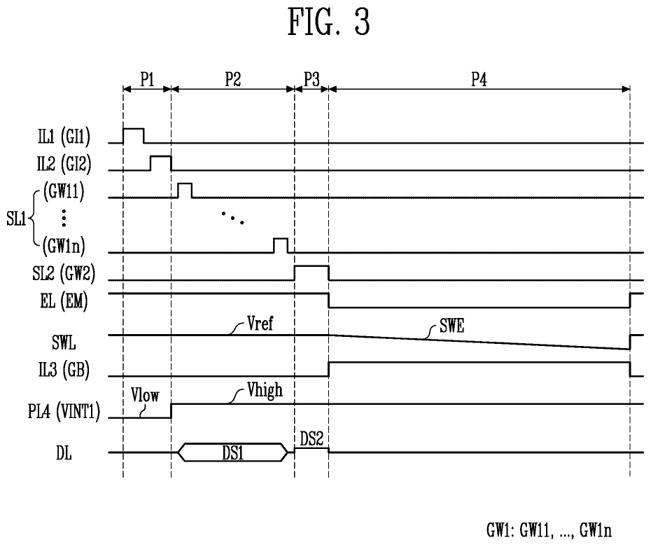

FIG. 3 is a waveform diagram illustrating an example of a method of driving the sub-pixel shown in FIGS. 1 and 2. The method of driving the sub-pixel SPX shown in FIG. 1 and the sub-pixel SPXa shown in FIG. 2 are the same (or substantially the same), and for convenience of description, the driving method of FIG. 3 is described in conjunction with FIG. 1.

Referring to FIGS. 1 and 3, the sub-pixel SPX may be divided into a first period P1, a second period P2, a third period P3, and a fourth period P4 and driven.

The first period P1 may be a period in which the first capacitor C1 (or the first node N1) and the second capacitor C2 (or the fourth node N4) are initialized. The first period P1 may be referred to as an initialization period.

The second period P2 is a period in which a first data signal DS1 and a voltage corresponding to a threshold voltage of the first transistor T1 are stored in the first capacitor C1. The second period P2 may be referred to as a first data signal writing period.

The third period P3 is a period in which a second data signal DS2 and a voltage corresponding to a threshold voltage of the seventh transistor T7 are stored in the second capacitor C2. The third period P3 may be referred to as a second data signal writing period.

The fourth period P4 is a period in which the sub-pixel SPX emits light during a time corresponding to the first data signal DS1. The fourth period P4 may be referred to as an emission period.

The first initialization power source VINT1 supplied to the fourth power line PL4 during the first period P1 may be set to a low first initialization voltage Vlow, and the first initialization power VINT1 may be set to a high first initialization voltage Vhigh during the second period P2 to the fourth period P4. The low first initialization voltage Vlow may be set to a voltage at which the first transistor T1 and the seventh transistor T7 may be turned on. For example, the low first initialization voltage Vlow may be set to a voltage lower than the first data signal DS1 and/or the second data signal DS2. The high first initialization voltage Vhigh may be set to a voltage higher than the low first initialization voltage Vlow.

A voltage of reference power Vref may be supplied to the sweep line SWL during the first period P1 and the second period P2. The reference power Vref may be set to a voltage higher than that of the low first initialization power Vlow.

The enable third initialization signal GB may be supplied to the third initialization line IL3 during the first period P1 to the third period P3. When the enable third initialization signal GB is supplied to the third initialization line IL3, the thirteenth transistor T13 may be turned on. When the thirteenth transistor T13 is turned on, the voltage of the second initialization power VINT2 may be supplied from the fifth power line PL5 to the first electrode of the light emitting element LD. When the voltage of the second initialization power VINT2 is supplied to the first electrode of the light emitting element LD, a parasitic capacitor of the light emitting element LD may be discharged, and thus a black expression ability may be relatively improved. In addition, when the voltage of the second initialization power VINT2 is supplied to the first electrode of the light emitting element LD, the light emitting element LD may be set to a non-emission state.

The disable emission control signal EM may be supplied to the emission control line EL during the first period P1 to the third period P3. When the disable emission control signal EM is supplied to the emission control line EL, the fifth transistor T5, the sixth transistor T6, the eleventh transistor T11, and the twelfth transistor T12 may be turned off.

When the fifth transistor T5 is turned off, the first power line PL1 and the second node N2 are electrically cut off. When the sixth transistor T6 is turned off, the third node N3 and the fourth node N4 are electrically cut off.

When the eleventh transistor T11 is turned off, the second power line PL2 and the fifth node N5 are electrically cut off. When the twelfth transistor T12 is turned off, the sixth node N6 and the first electrode of the light emitting element LD are electrically cut off. In this case, an unnecessary current being supplied to the light emitting element LD during the first period P1 to the third period P3 may be prevented or reduced.

During the first period P1, the enable first initialization signal GI1 may be supplied to the first initialization line IL1, and the enable second initialization signal GI2 may be supplied to the second initialization line IL2. The enable first initialization signal GI1 and the enable second initialization signal GI2 may be supplied sequentially so as not to overlap each other. However, the disclosure is not limited thereto, and the enable first initialization signal GI1 and the enable second initialization signal GI2 may be supplied to overlap at least a partial period.

When the enable first initialization signal GI1 is supplied to the first initialization line IL1, the fourth transistor T4 may be turned on. When the fourth transistor T4 is turned on, the low first initialization voltage Vlow may be supplied to the first node N1 from the fourth power line PL4. Then, the first capacitor C1 may be initialized by the voltage of the reference power Vref and the low first initialization voltage Vlow. In this case, the first capacitor C1 may be initialized regardless of a voltage applied in a previous frame.

When the enable second initialization signal GI2 is supplied to the second initialization line IL2, the tenth transistor T10 may be turned on. When the tenth transistor T10 is turned on, the low first initialization voltage Vlow may be supplied to the fourth node N4 from the fourth power line PL4. Then, the second capacitor C2 may be initialized by the voltage of the second power VDDA and the low first initialization voltage Vlow. In this case, the second capacitor C2 may be initialized regardless of a voltage applied in the previous frame.

The enable first scan signal GW1 may be supplied to the first scan line SL1 during the second period P2. Here, the first scan line SL1 may be formed for each horizontal line (for example, sub-pixels SPX connected to the same first scan line may be divided into one horizontal line or (pixel row), and the enable first scan signal GW1 (GW11 to GW1n) may be sequentially supplied to a first horizontal line to an n-th horizontal line (here, n is a natural number of 3 or more).

When the enable first scan signal GW1 is supplied to the first scan line SL1, the second transistor T2 and the third transistor T3 may be turned on. When the second transistor T2 is turned on, the data line DL and the second node N2 may be electrically connected. When the third transistor T3 is turned on, the first node N1 and the third node N3 may be electrically connected. Then, the first data signal DS1 supplied to the second node N2 through the data line DL may be supplied to the first node N1 via the first transistor T1 and the third transistor T3. Because the first transistor T1 is connected in the diode form, a voltage supplied to the first node N1 is a compensation voltage that reflects the threshold voltage of the first transistor T1 in the first data signal DS1. In this case, a threshold voltage deviation due to a process deviation of the first transistor T1 may be compensated. The compensation voltage applied to the first node N1 may be stored in the first capacitor C1 during the second period P2.

The first data signal DS1 may be different in each sub-pixel SPX correspondingly to a grayscale to be expressed. During the second period P2, the enable first scan signals GW11 to GW1n may be sequentially supplied in a horizontal line unit, and thus each sub-pixel SPX may store a voltage of the first data signal DS1 corresponding to the grayscale.

During the third period P3, the enable second scan signal GW2 may be supplied to the second scan line SL2. When the enable second scan signal GW2 is supplied to the second scan line SL2, the eighth transistor T8 and the ninth transistor T9 may be turned on.

When the eighth transistor T8 is turned on, the data line DL and the fifth node N5 may be electrically connected. When the ninth transistor T9 is turned on, the fourth node N4 and the sixth node N6 may be electrically connected. Then, the second data signal DS2 supplied to the fifth node N5 may be supplied to the fourth node N4 via the seventh transistor T7 and the ninth transistor T9. Because the seventh transistor T7 is connected in the diode form, a voltage supplied to the fourth node N4 is a compensation voltage that reflects the threshold voltage of the seventh transistor T7 in the second data signal DS2. In this case, a threshold voltage deviation due to a process deviation of the seventh transistor T7 may be compensated. The compensation voltage applied to the fourth node N4 may be stored in the second capacitor C2 during the third period P3.

According to some embodiments, the second data signal DS2 may be set to allow a constant current to flow to the light emitting element LD, and may have the same voltage in all sub-pixels SPX. According to some embodiments, the second data signal DS2 may have different voltages in the respective first sub-pixels, second sub-pixels, and third sub-pixels. However, the second data signal DS2 supplied to the same sub-pixels (for example, the first sub-pixels, the second sub-pixels, or the third sub-pixels) may have the same voltage.

Meanwhile, the high first initialization voltage Vhigh is supplied to the fourth power line PL4 during the second period P2 to the fourth period P4. In this case, a leakage current amount from the first node N1 and the fourth node N4 to the fourth power line PL4 may be reduced (or minimized).

During the fourth period P4, the disable third initialization signal GB may be supplied to the third initialization line IL3. When the disable third initialization signal GB is supplied to the third initialization line IL3, the thirteenth transistor T13 is turned off. In this case, the fifth power line PL5 and the first electrode of the light emitting element LD may be electrically cut off.

During the fourth period P4, the enable emission control signal EM may be supplied to the emission control line EL. When the enable emission control signal EM is supplied to the emission control line EL, the fifth transistor T5, the sixth transistor T6, the eleventh transistor T11, and the twelfth transistor T12 may be turned on.

When the fifth transistor T5 is turned on, the first power line PL1 and the second node N2 are electrically connected. When the sixth transistor T6 is turned on, the third node N3 and the fourth node N4 are electrically connected.

When the eleventh transistor T11 is turned on, the second power line PL2 and the fifth node N5 are electrically connected. When the twelfth transistor T12 is turned on, the sixth node N6 and the first electrode of the light emitting element LD are electrically connected.

Then, a current path connected to the third power line PL3 via the second power line PL2, the eleventh transistor T11, the seventh transistor T7, the twelfth transistor T12, and the light emitting element LD is formed. At this time, the seventh transistor T7 may supply a constant driving current to the light emitting element LD correspondingly to the second data signal DS2.

Meanwhile, a sweep signal SWE is supplied to the sweep line SWL during the fourth period P4. The sweep signal SWE may be gradually decreased from the voltage of the reference power Vref to a voltage lower than that of the reference power Vref.

At this time, the voltage of the first node N1 also gradually decreases due to coupling of the first capacitor C1. As the voltage of the first data signal DS1 supplied to the second period P2 increases, a time point when the first transistor T1 is turned on may be delayed. As the voltage of the first data signal DS1 supplied to the second period P2 decreases, the time point when the first transistor T1 is turned on may be earlier. When the first transistor T1 is turned on during the fourth period P4, a voltage of the fourth node N4 may be set to a voltage of the first power VDDW, and thus the seventh transistor T7 turns off.

When the seventh transistor T7 is turned off, the current path is blocked, and thus supply of driving current to the light emitting element LD may be stopped, and thus the light emitting element LD may be set to a non-emission state. As a time point when the driving current is stopped is earlier, a luminance of the sub-pixel SPX visible during a corresponding frame period may be decreased. As the time point when the driving current is stopped is delayed, the luminance of the sub-pixel SPX visible during the corresponding frame period may be increased.

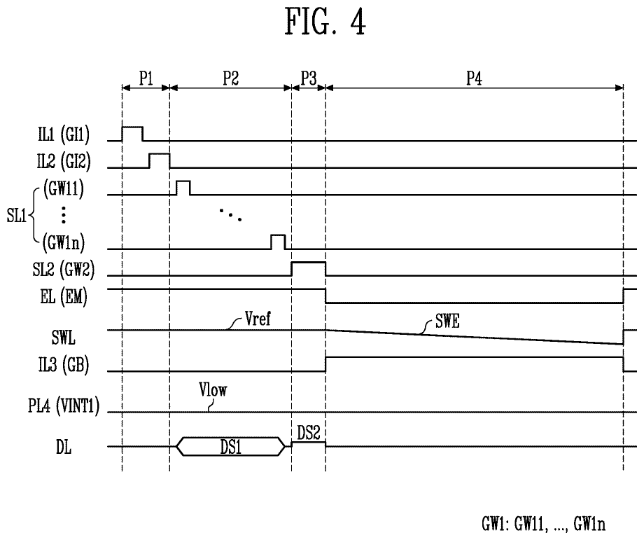

FIG. 4 is a waveform diagram illustrating aspects of a method of driving the sub-pixel shown in FIGS. 1 and 2 according to some embodiments of the present disclosure.

Referring to FIG. 4, the sub-pixel SPX may be divided into the first period P1, the second period P2, the third period P3, and the fourth period P4 and driven.

During the first period P1 to the fourth period P4, the first initialization power VINT1 may maintain the low first initialization voltage Vlow. That is, according to some embodiments of the present disclosure, the first initialization power VINT1 may maintain a constant voltage (that is, the low first initialization voltage Vlow). In FIG. 4, a remaining driving waveform except for the first initialization power VINT1 is the same as that of FIG. 3, and an overlapping description is omitted.

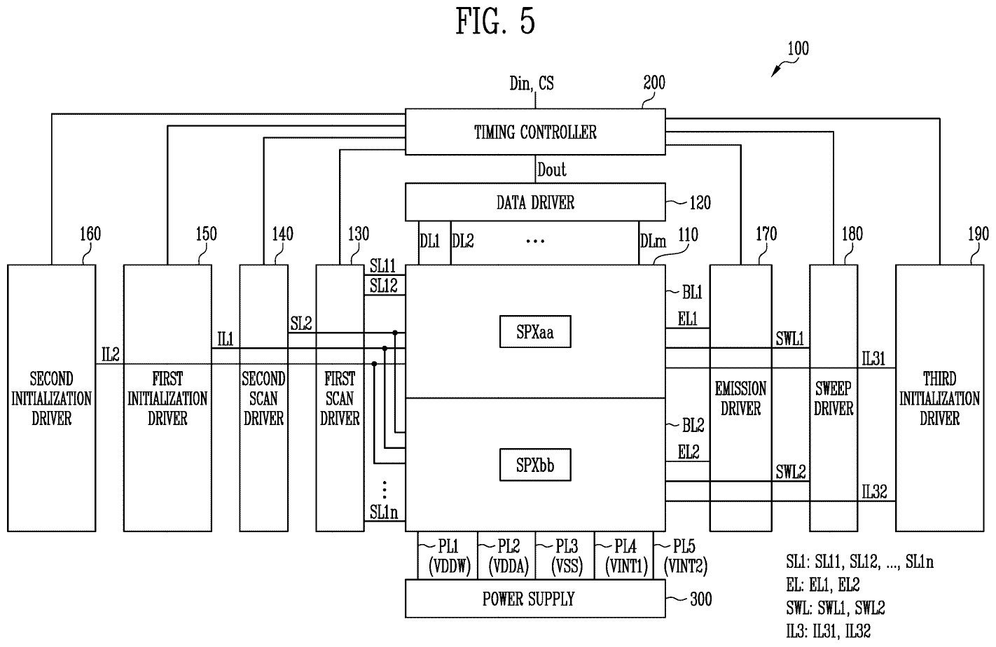

FIG. 5 is a block diagram illustrating a display device according to some embodiments of the present disclosure.

Referring to FIG. 5, the display device 100 according to some embodiments of the present disclosure may include a display unit 110 (or a display panel), a data driver 120, a first scan driver 130, a second scan driver 140, a first initialization driver 150, a second initialization driver 160, an emission driver 170, a sweep driver 180, a third initialization driver 190, a timing controller 200, and a power supply 300.

Each of the data driver 120, the first scan driver 130, the second scan driver 140, the first initialization driver 150, the second initialization driver 160, the emission driver 170, the sweep driver 180, the third initialization driver 190, the timing controller 200, and the power supply 300 may be configured as one integrated chip (IC) or two or more configurations (at least two of 120, 130, 140, 150, 160, 170, 180, 190, 200, and 300 may be configured as one IC. In addition, a portion of the drivers 120, 130, 140, 150, 160, 170, 180, 190, 200, and 300 may not be configured as a chip and may be formed on a panel identically to the sub-pixel SPX1. For example, at least one of the first scan driver 130, the second scan driver 140, the first initialization driver 150, the second initialization driver 160, the emission driver 170, the sweep driver 180, and the third initialization driver 190 may be formed on the panel.

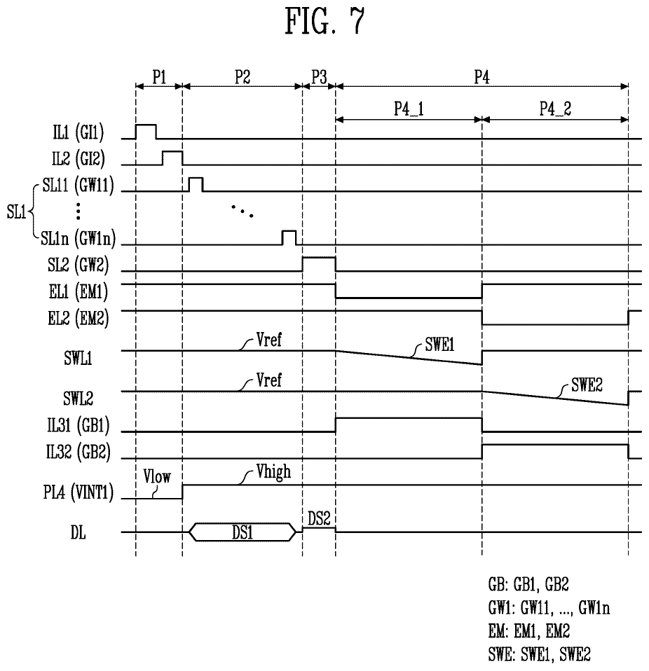

The display unit 110 may be partitioned into a plurality of blocks BL1 and BL2. Each of the blocks BL1 and BL2 may include two or more sub-pixels. According to some embodiments, the display unit 110 may include a first block BL1 and a second block BL2. The first block BL1 may be positioned on one side (or an upper side) of the panel and may include a sub-pixel SPXaa. The second block BL2 may be positioned on another side (or a lower side) of the panel and may include a sub-pixel SPXbb. A structure of each of the sub-pixels SPXaa and SPXbb may be the same (or substantially the same) as the sub-pixel SPX or SPXa shown in FIG. 1 or 2. Emission times of the sub-pixel SPXaa included in the first block BL1 and the sub-pixel SPXbb included in the second block BL2 may not overlap and the sub-pixel SPXaa included in the first block BL1 and the sub-pixel SPXbb included in the second block BL2 may emit light at different times. A detailed description in this regard is be provided later with reference to FIGS. 7 to 9B.

The timing controller 200 may receive input data Din and a control signal CS from a processor. The processor may be an application processor, a central processing unit (CPU), a graphics processing unit (GPU), or the like.

The timing controller 200 may correct the input data Din and generate output data Dout. For example, the timing controller 200 may generate the output data Dout by correcting the input data Din correspondingly to a temperature of the display unit 110, an optical measurement result (measurement in a process), a dimming level, and the like. In addition, the timing controller 200 may generate driving signals for controlling the drivers 120, 130, 140, 150, 160, 170, 180, 190, and 300 in response to the control signal CS, and supply the driving signals to the respective drivers 120, 130, 140, 150, 160, 170, 180, 190, and 300.

The data driver 120 may generate a data signal having a voltage (e.g., a set or predetermined voltage) using the output data Dout and supply the data signal to data lines DL1 to DLm (m is a natural number of 3 or more). Here, the data driver 120 may supply the first data signal DS1 to the data lines DL1 to DLm during the second period P2 shown in FIG. 7, and supply the second data signal DS2 to the data lines DL1 to DLm during the third period P3.

As described above, the voltage of the first data signal DS1 may be set correspondingly to a grayscale of the output data Dout. In this case, the emission time of each of the sub-pixels SPXaa and SPXbb may be controlled correspondingly to the grayscale of the output data Dout.

As described above, the second data signal DS2 may be set to allow a constant current to flow in each of the sub-pixels SPXaa and SPXbb. For example, the voltage of the second data signal DS2 may be set to be the same in each of the sub-pixels SPXaa and SPXbb. For example, the data driver 120 may supply a first color data signal to first sub-pixels that emit a first color among the sub-pixels SPXaa and SPXbb, and supply a second color data signal to second sub-pixels that emit a second color, and supply a third color data signal to third sub-pixels that emit a third color. The first color data signal, the second color data signal, and the third color data signal may be set to the same or different voltages.

The first scan driver 130 may supply the enable first scan signal GW1 to the first scan line SL1. Here, the first scan line SL1 may include a plurality of first scan lines SL11, SL12, . . . , and SL1n. The first scan lines SL11 to SL1n may be positioned for each horizontal line (or pixel row). The first scan driver 130 may sequentially supply enable first scan signals GW11 to GW1n to the first scan lines SL11 to SL1n during the second period P2. Then, the sub-pixels SPXaa and SPXbb may be sequentially selected in a horizontal line unit and may receive the first data signal DS1.

The second scan driver 140 may supply the enable second scan signal GW2 to the second scan line SL2. The second scan line SL2 may be commonly connected to the sub-pixels SPXaa and SPXbb included in the first block BL1 and the second block BL2. The second scan driver 140 may supply the enable second scan signal GW2 during the third period P3, and thus the second data signal DS2 may be supplied to the sub-pixels SPXaa and SPXbb during the third period P3.

The first initialization driver 150 may supply the enable first initialization signal GI1 to the first initialization line IL1. The first initialization line IL1 may be commonly connected to the sub-pixels SPXaa and SPXbb included in the first block BL1 and the second block BL2. The first initialization driver 150 may supply the enable first initialization signal GI1 during the first period P1, and thus the first node N1 of each of the sub-pixels SPXaa and SPXbb may be initialized during the first period P1.

The second initialization driver 160 may supply the enable second initialization signal GI2 to the second initialization line IL2. The second initialization line IL2 may be commonly connected to the sub-pixels SPXaa and SPXbb included in the first block BL1 and the second block BL2. The second initialization driver 160 may supply the enable second initialization signal GI2 during the first period P1, and thus the fourth node N4 of each of the sub-pixels SPXaa and SPXbb may be may be initialized during the first period P1.

The third initialization driver 190 may supply the third initialization signal GB to the third initialization line IL3. Here, the third initialization line IL3 may include a plurality of third initialization lines IL31 and IL32. The third initialization line IL31 may be commonly connected to the sub-pixels SPXaa positioned in the first block BL1, and the third initialization line IL32 may be connected to the sub-pixels SPXbb positioned in the second block BL2. That is, the third initialization lines IL31 and IL32 may be respectively formed for the respective blocks BL1 and BL2 and may be electrically connected to the sub-pixels SPXaa or SPXbb included in the blocks BL1 or BL2 in which oneself is positioned.

The third initialization driver 190 may supply the disable third initialization signal GB1 to the sub-pixels SPXaa positioned in the first block BL1 via the third initialization line IL31 in a first sub-period P4_1 shown in FIG. 7, and supply the disable third initialization signal GB2 to the sub-pixels SPXbb positioned in the second block BL2 via the third initialization line IL32 in a second sub-period P4_2. In this case, the sub-pixels SPXaa positioned in the first block BL1 may emit light in the first sub-period PL4_1, and the sub-pixels SPXbb positioned in the second block BL2 may emit light in the second sub-period P4_2.

The emission driver 170 may supply the emission control signal EM to the emission control line EL. Here, the emission control line EL may include a plurality of emission control lines EL1 and EL2. The emission control line EL1 may be commonly connected to the sub-pixels SPXaa positioned in the first block BL1, and the emission control line EL2 may be commonly connected to the sub-pixels SPXbb positioned in the second block BL2. That is, the emission control lines EL1 and EL2 may be respectively formed for the respective blocks BL1 and BL2, and may be electrically connected to the sub-pixels SPXaa or SPXbb included in the blocks BL1 or BL2 in which oneself is positioned.

The emission driver 170 may supply an enable emission control signal EM1 to the sub-pixels SPXaa positioned in the first block BL1 via the emission control line EL1 in the first sub-period P4_1, and supply an enable emission control signal EM2 to the sub-pixels SPXbb positioned in the second block BL2 via the emission control line EL2 in the second sub-period P4_2. In this case, the sub-pixels SPXaa positioned in the first block BL1 may emit light in the first sub-period PL4_1, and the sub-pixels SPXbb positioned in the second block BL2 may emit light in the second sub-period P4_2.

The sweep driver 180 may supply the sweep signal SWE to the sweep line SWL. Here, the sweep line SWL may include a plurality of sweep lines SWL1 and SWL2. The sweep line SWL1 may be commonly connected to the sub-pixels SPXaa positioned in the first block BL1, and the sweep line SWL2 may be commonly connected to the sub-pixels SPXbb positioned in the second block BL2. That is, the sweep lines SWL1 and SWL2 may be respectively formed for the respective blocks BL1 and BL2, and may be electrically connected to the sub-pixels SPXaa or SPXbb included in the blocks BL1 or BL2 in which oneself is positioned.

The sweep driver 180 may supply a sweep signal SWE1 to the sub-pixels SPXaa positioned in the first block BL1 via the sweep line SWL1 in the first sub-period P4_1 shown in FIG. 7, and supply a sweep signal SWE2 to the sub-pixels SPXbb positioned in the second block BL2 via the sweep line SWL2 in the second sub-period P4_2.

The power supply 300 may supply a voltage (e.g., a set or predetermined voltage) to the display unit 110. For example, the power supply 300 may supply the first power VDDW to the first power line PL1, supply the second power VDDA to the second power line PL2, supply the third power VSS to the third power line PL3, supply the first initialization power VINT1 to the fourth power line PL4, and supply the second initialization power VINT2 to the fifth power line PL5. The first power line PL1, the second power line PL2, the third power line PL3, the fourth power line PL5, and the fifth power line PL5 may be common to the sub-pixels SPXaa and SPXbb, but the disclosure is not limited thereto.

For example, each of the first power line PL1, the second power line PL2, the third power line PL3, the fourth power line PL5, and the fifth power line PL5 may include a plurality of power lines, and each of the sub-pixels SPXaa and SPXbb may be connected to one of the plurality of power lines.

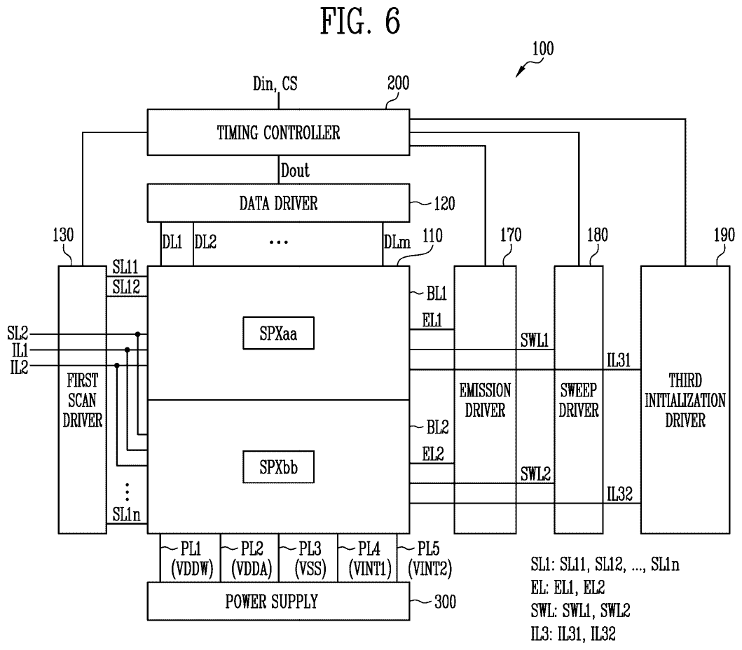

FIG. 6 is a block diagram illustrating a display device according to some embodiments of the present disclosure. When describing FIG. 6, an overlapping description of the same configuration as FIG. 5 is omitted.

Referring to FIG. 6, the display device 100 according to some embodiments of the present disclosure may include the display unit 110 (or the display panel), the data driver 120, the first scan driver 130, the emission driver 170, the sweep driver 180, the third initialization driver 190, the timing controller 200, and the power supply 300.

Each of the second scan line SL2, the first initialization line IL1, and the second initialization line IL2 is common to the sub-pixels SPXaa and SPXbb positioned in the first block BL1 and the second block BL2. In this case, the second scan line SL2, the first initialization line IL1, and the second initialization line IL2 may not be connected to a separate driver and may receive a signal supplied from an outside.

For example, the second scan line SL2 may receive the second scan signal GW2 from the controller 200, the first initialization line IL1 may receive the first initialization signal GI1 from the timing controller 200, and the second initialization line IL2 may receive the second initialization signal GI2 from the controller 200.

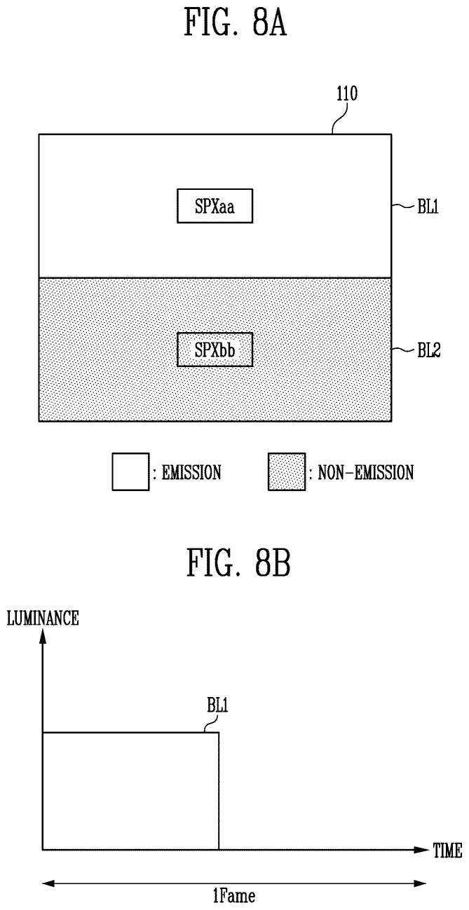

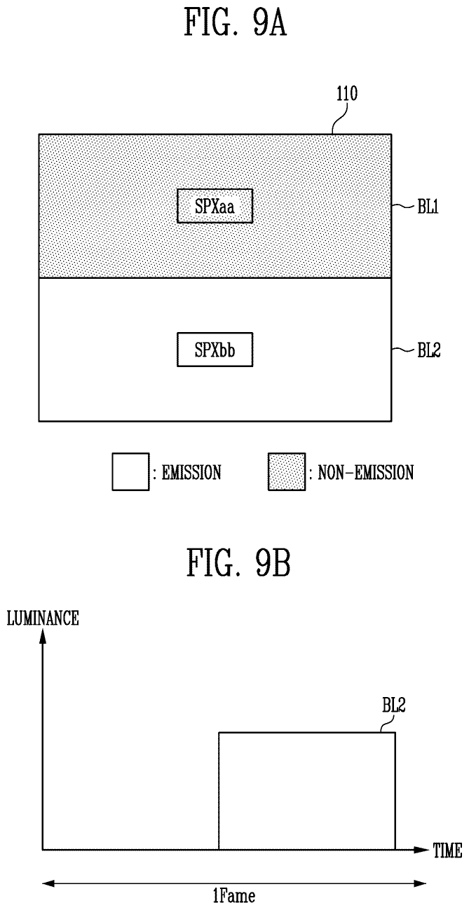

FIG. 7 is a waveform diagram illustrating a method of driving the display device shown in FIGS. 5 and 6. FIGS. 8A to 9B are diagrams illustrating an emission area of the display unit. In FIGS. 8B and 9B, an X-axis represents a time of one frame, and a Y-axis represents the luminance of the sub-pixels. It is assumed that the luminance of the sub-pixels is the same in FIGS. 8B and 9B. When describing FIG. 7, a part described with reference to FIG. 3 is briefly described (or omitted).

When describing FIG. 7, FIG. 7 is described in conjunction with the sub-pixel of FIG. 1.

Referring to FIGS. 1, 5, and 6, each of the sub-pixels SPX: SPXaa and SPXbb included in the display device 100 may be divided into the first period P1, the second period P2, the third period P3, and the fourth period P4 and driven. The fourth period P4 may include a first sub-period P4_1 and a second sub-period P4_2.

During the first period P1, the enable first initialization signal GI1 may be supplied to the first initialization line IL1, and the enable second initialization signal GI2 may be supplied to the second initialization line IL2. The enable first initialization signal GI1 and the enable second initialization signal GI2 may be supplied sequentially so as not to overlap each other.

When the enable first initialization signal GI1 is supplied to the first initialization line IL1, the fourth transistor T4 included in each of the sub-pixels SPXaa and SPXbb may be turned on. When the fourth transistor T4 is turned on, the low first initialization voltage Vlow may be supplied to the first node N1 from the fourth power line PL4. Then, the first capacitor C1 included in each of the sub-pixels SPXaa and SPXbb may be initialized by the voltage of the reference power Vref and the low first initialization voltage Vlow.

When the enable second initialization signal GI2 is supplied to the second initialization line IL2, the tenth transistor T10 included in each of the sub-pixels SPXaa and SPXbb may be turned on. When the tenth transistor T10 is turned on, the low first initialization voltage Vlow may be supplied to the fourth node N4 from the fourth power line PL4. Then, the second capacitor C2 included in each of the sub-pixels SPXaa and SPXbb may be initialized by the voltage of the second power VDDA and the low first initialization voltage Vlow.

During the second period P2, the enable first scan signals GW11 to GW1n may be sequentially supplied to the first scan lines SL11 to SL1n. When the enable first scan signals GW11 to GW1n are sequentially supplied to the first scan lines SL11 to SL1n, the second transistor T2 and the third transistor T3 included in each of the sub-pixels SPXaa and SPXbb in the horizontal line unit may be sequentially turned on. Then, the first data signal DS1 may be supplied to the sub-pixels SPXaa and SPXbb in the horizontal line unit. That is, during the second period P2, a voltage corresponding to the first data signal DS1 may be stored in the first capacitor C1 included in each of the sub-pixels SPXaa and SPXbb.

During the third period P3, the enable second scan signal GW2 may be supplied to the second scan line SL2. When the enable second scan signal GW2 is supplied to the second scan line SL2, the eighth transistor T8 and the ninth transistor T9 included in each of the sub-pixels SPXaa and SPXbb may be turned on. In this case, a voltage corresponding to the second data signal DS2 may be stored in the second capacitor C2 included in each of the sub-pixels SPXaa and SPXbb.

Meanwhile, during the second period P2 to the fourth period P4, the high first initialization voltage Vhigh is supplied to the fourth power line PL4. In this case, a leakage current amount from the first node N1 and the fourth node N4 to the fourth power line PL4 may be reduced (or minimized). In addition, as shown in FIG. 4, during the second period P2 to the fourth period P4, the low first initialization voltage Vlow may be supplied to the fourth power line PL4.

During the first sub-period P4_1 of the fourth period P4, the disable third initialization signal GB1 may be supplied to the third initialization line IL31 positioned in the first block BL1. In addition, during the first sub-period P4_1, the enable emission control signal EM1 may be supplied to the emission control line EL1 positioned in the first block BL1.

When the disable third initialization signal GB1 is supplied to the third initialization line IL31, the thirteenth transistor T13 included in each of the sub-pixels SPXaa is turned off. In this case, the fifth power line PL5 and the first electrode of the light emitting element LD included in each of the sub-pixels SPXaa may be electrically cut off.

When the enable emission control signal EM1 is supplied to the emission control line EL1, the fifth transistor T5, the sixth transistor T6, the eleventh transistor T11, and the twelfth transistor T12 included in each of the sub-pixels SPXaa may be turned on. At this time, the seventh transistor T7 included in each of the sub-pixels SPXaa may supply a driving current corresponding to a constant current to the light emitting element LD correspondingly to the second data signal DS2.

Meanwhile, during the first sub-period P4_1, the sweep signal SWE1 is supplied to the sweep line SWL1 positioned in the first block BL1. The sweep signal SWE1 may be gradually decreased from the voltage of the reference power Vref to a voltage lower than the reference power Vref.

At this time, the voltage of the first node N1 included in each of the sub-pixels SPXaa gradually decreases due to coupling of the first capacitor C1 included in each of the sub-pixels SPXaa. As the voltage of the first data signal DS1 supplied in the second period P2 is increased, a time point when the first transistor T1 included in each of the sub-pixels SPXaa is turned on may be delayed. As the voltage of the first data signal DS1 supplied in the second period P2 is decreased, the time point when the first transistor T1 included in each of the sub-pixels SPXaa is turned on may be earlier.

In this case, a time point when each of the sub-pixels SPXaa included in the first block BL1 does not emit light may be set differently correspondingly to the first data signal DS1. When the first transistor T1 included in each of the sub-pixels SPXaa is turned on during the first sub-period P4_1, the voltage of the fourth node N4 included in each of the sub-pixels SPXaa may be set to the voltage of the first power VDDW, and thus the seventh transistor T7 included in each of the sub-pixels SPXaa is turned off.

When the seventh transistor T7 included in each of the sub-pixels SPXaa is turned off, the current path may be blocked, and thus supply of the driving current to the light emitting element LD included in each of the sub-pixels SPXaa may be stopped. Accordingly, the light emitting element LD may be set to the non-emission state. As a time point when the driving current is stopped is earlier, a luminance of the sub-pixel SPXaa visible during a corresponding frame period may be decreased. As the time point when the driving current is stopped is delayed, the luminance of the sub-pixel SPXaa visible during the corresponding frame period may be increased.

Meanwhile, in the first sub-period P4_1, as shown in FIGS. 8A and 8B, the sub-pixels SPXaa included in the first block BL1 may be set to an emission state, and the sub-pixels SPXbb included in the second block BL2 may be set to a non-emission state. That is, according to some embodiments of the present disclosure, the sub-pixels SPXaa and SPXbb included in the blocks BL1 and BL2 may emit light at different times. In this case, a voltage drop (IR-drop) of the second power VDDA may be reduced, and thus display quality may be relatively improved.

During the second sub-period P4_2 of the fourth period P4, the disable third initialization signal GB2 may be supplied to the third initialization line IL32 positioned in the second block BL2. In addition, during the second sub-period P4_2, the enable emission control signal EM2 may be supplied to the emission control line EL2 positioned in the second block BL2.

When the disable third initialization signal GB2 is supplied to the third initialization line IL32, the thirteenth transistor T13 included in each of the sub-pixels SPXbb is turned off. In this case, the fifth power line PL5 and the first electrode of the light emitting element LD included in each of the sub-pixels SPXbb may be electrically cut off.

When the enable emission control signal EM2 is supplied to the emission control line EL2, the fifth transistor T5, the sixth transistor T6, the eleventh transistor T11, and the twelfth transistor T12 included in each of the sub-pixels SPXbb may be turned on. At this time, the seventh transistor T7 included in each of the sub-pixels SPXbb may supply a driving current corresponding to a constant current to the light emitting element LD correspondingly to the second data signal DS2.

Meanwhile, during the second sub-period P4_2, the sweep signal SWE2 is supplied to the sweep line SWL2 included in the second block BL2. The sweep signal SWE2 may be gradually decreased from the voltage of the reference power Vref to a voltage lower than the reference power Vref.

At this time, the voltage of the first node N1 included in each of the sub-pixels SPXbb gradually decreases due to coupling of the first capacitor C1 included in each of the sub-pixels SPXbb. As the voltage of the first data signal DS1 supplied in the second period P2 is increased, a time point when the first transistor T1 included in each of the sub-pixels SPXbb is turned on may be delayed. As the voltage of the first data signal DS1 supplied in the second period P2 is decreased, the time point when the first transistor T1 included in each of the sub-pixels SPXbb is turned on may be earlier.

In this case, a time point when each of the sub-pixels SPXbb included in the second block BL2 does not emit light may be set differently correspondingly to the first data signal DS1. When the first transistor T1 included in each of the sub-pixels SPXbb is turned on during the second sub-period P4_2, the voltage of the fourth node N4 included in each of the sub-pixels SPXbb may be set to the voltage of the first power VDDW, and thus the seventh transistor T7 included in each of the sub-pixels SPXbb is turned off.

When the seventh transistor T7 included in each of the sub-pixels SPXbb is turned off, the current path is blocked, and thus supply of the driving current to the light emitting element LD included in each of the sub-pixels SPXbb may be stopped. Accordingly, the light emitting element LD may be set to the non-emission state. As a time point when the driving current is stopped is earlier, a luminance of the sub-pixel SPXbb visible during a corresponding frame period may be decreased. As the time point when the driving current is stopped is delayed, the luminance of the sub-pixel SPXbb visible during the corresponding frame period may be increased.

Meanwhile, in the second sub-period P4_2, as shown in FIGS. 9A and 9B, the sub-pixels SPX included in the first block BL1 may be set to the non-emission state, and the sub-pixels SPX included in the second block BL2 may be set to the emission state. That is, according to some embodiments of the present disclosure, the sub-pixels SPXaa and SPXbb included in the blocks BL1 and BL2 may emit light at different times. In this case, the voltage drop (IR-drop) of the second power VDDA may be reduced, and thus display quality may be relatively improved.

In addition, when the fourth period P4 is divided into the first sub-period P4_1 and the second sub-period P4_2, display quality may be relatively improved. For example, when the first transistor T1 is turned on by the sweep signal SWE, the voltage of the fourth node N4 may be increased, and thus the seventh transistor T7 may be turned off. Here, when a period in which the voltage of the fourth node N4 is increased due to the turn-on of the first transistor T1 is increased, an unintended driving current may be supplied to the light emitting element LD due to the voltage increase of the fourth node N4.

When the fourth period P4 is divided into the first sub-period P4_1 and the second sub-period P4-2 according to some embodiments of the present disclosure, a slope of the sweep signal SWE may be increased. When the slope of the sweep signal SWE is increased, the voltage of the fourth node N4 may be quickly increased to the first power VDDW due to the turn-on of the first transistor T1, and thus the unintended driving current being supplied to the light emitting element LD may be prevented or reduced.

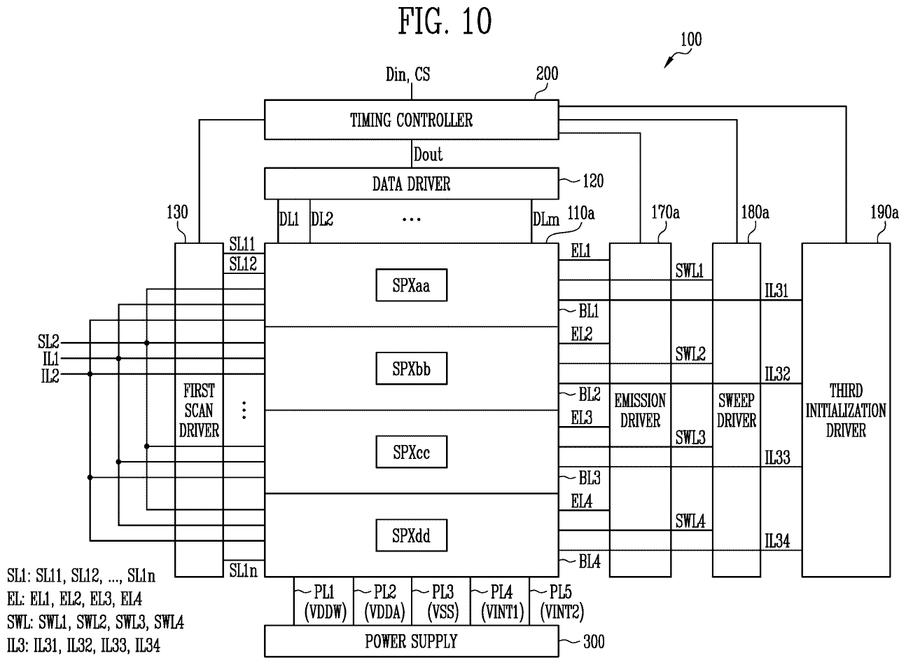

FIG. 10 is a block diagram illustrating a display device according to some embodiments of the present disclosure. When describing FIG. 10, an overlapping description of a configuration similar or identical to that of FIGS. 5 and 6 is omitted.

Referring to FIG. 10, the display device 100 according to some embodiments of the present disclosure may include a display unit 110a (or the display panel), the data driver 120, the first scan driver 130, an emission driver 170a, a sweep driver 180a, a third initialization driver 190a, the timing controller 200, and the power supply 300. According to some embodiments, as shown in FIG. 5, the display device 100 may additionally include the second scan driver 140, the first initialization driver 150, and the second initialization driver 160.

The display unit 110 may be partitioned into a plurality of blocks BL1, BL2, BL3, and BL4. Each of the blocks BL1 to BL4 may include two or more sub-pixels. For example, the display unit 110 may include a first block BL1, a second block BL2, a third block BL3, and a fourth block BL4. That is, according to some embodiments of the present disclosure, the display unit 110 may include at least two blocks.

The first block BL1 may include a sub-pixel SPXaa. The second block BL2 may include a sub-pixel SPXbb. The third block BL3 may include a sub-pixel SPXcc.

The fourth block BL4 may include a sub-pixel SPXdd. A structure of each of the sub-pixels SPXaa, SPXbb, SPXcc, SPXdd may be the same (or substantially the same) as the sub-pixels SPX and SPXa shown in FIG. 1 or 2.

Emission times of the sub-pixels SPXaa, SPXbb, SPXcc, and SPXdd included in the different blocks BL1 to BL4 do not overlap. For example, each of the sub-pixels SPXaa, SPXbb, SPXcc, and SPXdd included in the different blocks BL1 to BL4 may emit light at different times.

The second scan line SL2, the first initialization line IL1, and the second initialization line IL2 may be commonly connected to the sub-pixels SPXaa, SPXbb, SPXcc, and SPXdd.

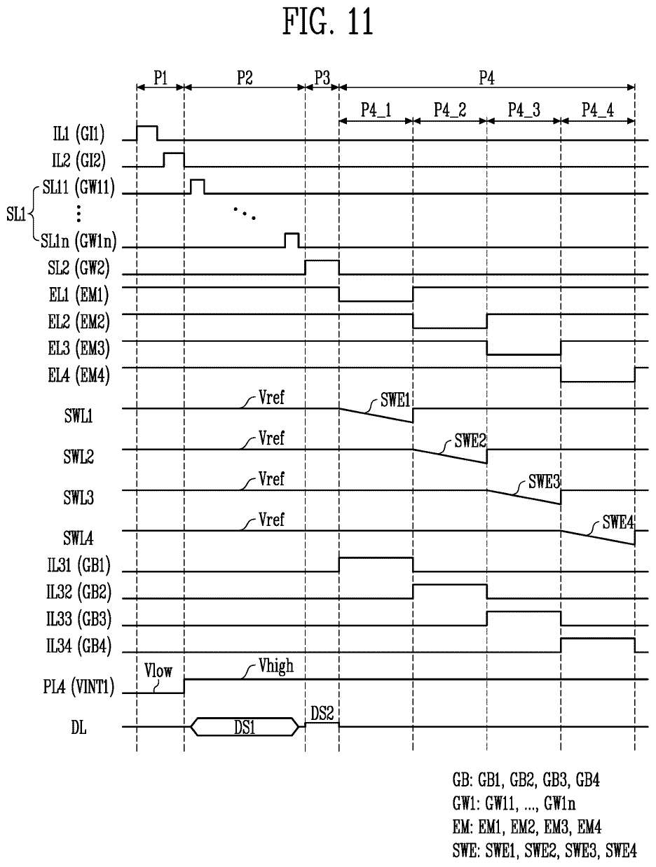

The first scan line SL1 may include a plurality of first scan lines SL11, SL12, . . . , and SL1n, and the first scan lines SL11 to SL1n may be positioned in each horizontal line. The first scan driver 130 may sequentially supply the enable first scan signals GW11 to GW1n to the first scan lines SL11 to SL1n during the second period P2 shown in FIG. 11. Then, the sub-pixels SPXaa, SPXbb, SPXcc, and SPXdd may be sequentially selected in the horizontal line unit and receive the first data signal DS1.

The third initialization line IL3 may include a plurality of third initialization lines IL31, IL32, IL33, and IL34. For example, different third initialization lines IL31 to IL34 may be formed in the respective blocks BL1, BL2, BL3, and BL4. The third initialization line IL31 may be commonly connected to the sub-pixels SPXaa positioned in the first block BL1. The third initialization line IL32 may be commonly connected to the sub-pixels SPXbb positioned in the second block BL2. The third initialization line IL33 may be commonly connected to the sub-pixels SPXcc positioned in the third block BL3. The third initialization line IL34 may be commonly connected to the sub-pixels SPXdd positioned in the fourth block BL4.

The third initialization driver 190a may supply a disable third initialization signal GB1 to the sub-pixels SPXaa positioned in the first block BL1 via the third initialization line IL31 in a first sub-period P4_1 shown in FIG. 11, supply a disable third initialization signal GB2 to the sub-pixels SPXbb positioned in the second block BL2 via the third initialization line IL32 in a second sub-period P4_2, supply a disable third initialization signal GB3 to the sub-pixels SPXcc positioned in the third block BL3 via the third initialization line IL33 in a third sub-period P4_3, and supply a disable third initialization signal GB4 to the sub-pixels SPXdd positioned in the fourth block BL4 via the third initialization line IL34 in a fourth sub-period P4_4.

In this case, the sub-pixels SPXaa positioned in the first block BL1 may emit light in the first sub-period PL4_1, and the sub-pixels SPXbb positioned in the second block BL2 may emit light in the second sub-period P4_2. In addition, the sub-pixels SPXcc positioned in the third block BL3 may emit light in the third sub-period PL4_3, and the sub-pixels SPXdd positioned in the fourth block BL4 may emit light in the fourth sub-period PL4_4.

The emission control line EL may include a plurality of emission control lines EL1, EL2, EL3, and EL4. For example, different emission control lines EL1 to EL4 may be formed in the respective blocks BL1, BL2, BL3, and BL4. The emission control line EL1 may be commonly connected to the sub-pixels SPXaa positioned in the first block BL1. The emission control line EL2 may be commonly connected to the sub-pixels SPXbb positioned in the second block BL2. The emission control line EL3 may be commonly connected to the sub-pixels SPXcc positioned in the third block BL3. The emission control line EL4 may be commonly connected to the sub-pixels SPXdd positioned in the fourth block BL4.

The emission driver 170a may supply an enable emission control signal EM1 to the sub-pixels SPXaa positioned in the first block BL1 via the emission control line EL1 in the first sub-period P4_1 shown in FIG. 11, supply an enable emission control signal EM2 to the sub-pixels SPXbb positioned in the second block BL2 via the emission control line EL2 in the second sub-period P4_2, supply an enable emission control signal EM3 to the sub-pixels SPXcc positioned in the third block BL3 via the emission control line EL3 in the third sub-period P4_3, and supply an enable emission control signal EM4 to the sub-pixels SPXdd positioned in the fourth block BL4 via the emission control line EL4 in the fourth sub-period P4_4.

In this case, the sub-pixels SPXaa positioned in the first block BL1 may emit light in the first sub-period PL4_1, and the sub-pixels SPXbb positioned in the second block BL2 may emit light in the second sub-period P4_2. In addition, the sub-pixels SPXcc positioned in the third block BL3 may emit light in the third sub-period PL4_3, and the sub-pixels SPXdd positioned in the fourth block BL4 may emit light in the fourth sub-period PL4_4.

The sweep line SWL may include a plurality of sweep lines SWL1, SWL2, SWL3, and SWL4. For example, the different sweep lines SWL1 to SWL4 may be formed in the respective blocks BL1, BL2, BL3, and BL4. The sweep line SWL1 may be commonly connected to the sub-pixels SPXaa positioned in the first block BL1. The sweep line SWL2 may be commonly connected to the sub-pixels SPXbb positioned in the second block BL2. The sweep line SWL3 may be commonly connected to the sub-pixels SPXcc positioned in the third block BL3. The sweep line SWL4 may be commonly connected to the sub-pixels SPXdd positioned in the fourth block BL4.

The sweep driver 180a may supply the voltage of the reference power Vref to the sweep lines SWL1 to SWL4 during the first period P1 to the third period P3. The sweep driver 180a may supply a sweep signal SWE1 to the sub-pixels SPXaa positioned in the first block BL1 via the sweep line SWL1 in the first sub-period P4_1, supply a sweep signal SWE2 to the sub-pixels SPXbb positioned in the second block BL2 via the sweep line SWL2 in the second sub-period P4_2, supply a sweep signal SWE3 to the sub-pixels SPXcc positioned in the third block BL3 via the sweep line SWL3 in the third sub-period P4_3, and supply a sweep signal SWE4 to the sub-pixels SPXdd positioned in the fourth block BL4 via the sweep line SWL4 in the fourth sub-period P4_4.

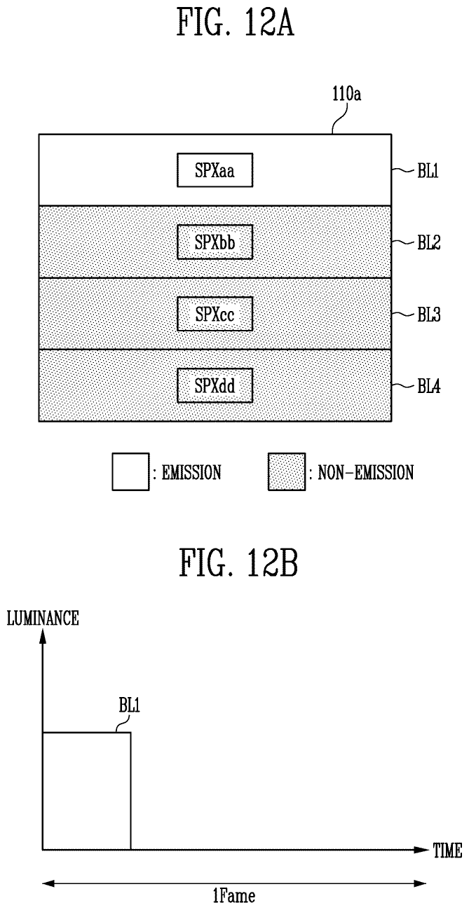

FIG. 11 is a waveform diagram illustrating a method of driving the display device shown in FIG. 10. FIGS. 12A to 15B are diagrams illustrating an emission area of the display unit. In FIGS. 12B, 13B, 14B and 15B, an X-axis represents a time of one frame, and a Y-axis represents the luminance of the sub-pixels. It is assumed that the luminance of the sub-pixels is the same in FIGS. 12B, 13B, 14B and 15B. When describing FIG. 11, a part similar to FIG. 7 is briefly described. When describing FIG. 11, FIG. 11 is described in conjunction with the sub-pixel of FIG. 1.

Referring to FIGS. 1, 10, and 11, each of the sub-pixels SPX: SPXaa, SPXbb, SPXcc, and SPXdd included in the display device 100 may be divided into the first period P1, the second period P2, the third period P3, and the fourth period P4 and driven. The fourth period P4 may include the first sub-period P4_1, the second sub-period P4_2, the third sub-period P4_3, and the fourth sub-period P4_4. For example, when j (j is a natural number of 2 or more) blocks are included in the display unit 110a, the fourth period P4 may include j sub-periods.

During the first period P1, the enable first initialization signal GI1 may be supplied to the first initialization line IL1, and the enable second initialization signal GI2 may be supplied to the second initialization line IL2 so as not to overlap the enable first initialization signal GI1 (or so as to overlap the enable first initialization signal GI1 in a partial period).

When the enable first initialization signal GI1 is supplied to the first initialization line IL1, the fourth transistor T4 included in each of the sub-pixels SPXaa, SPXbb, SPXcc, and SPXdd may be turned on, and thus the first capacitor C1 included in each of the sub-pixels SPXaa, SPXbb, SPXcc, and SPXdd may be initialized.

When the enable second initialization signal GI2 is supplied to the second initialization line IL2, the tenth transistor T10 included in each of the sub-pixels SPXaa, SPXbb, SPXcc, SPXdd may be turned on, and thus the second capacitor C2 included in each of the sub-pixels SPXaa, SPXbb, SPXcc, and SPXdd may be initialized.

During the second period P2, the enable first scan signals GW11 to GW1n may be sequentially supplied to the first scan lines SL11 to SL1n. Then, the second transistor T2 and the third transistor T3 included in each of the sub-pixels SPXaa, SPXbb, SPXcc, and SPXdd may be sequentially turned on. In this case, the voltage corresponding to the first data signal DS1 may be stored in the first capacitor C1 included in each of the sub-pixels SPXaa, SPXbb, SPXcc, and SPXdd.

During the third period P3, the enable second scan signal GW2 may be supplied to the second scan line SL2. Then, the eighth transistor T8 and the ninth transistor T9 included in each of the sub-pixels SPXaa, SPXbb, SPXcc, and SPXdd may be turned on. In this case, the voltage corresponding to the second data signal DS2 may be stored in the second capacitor C2 included in each of the sub-pixels SPXaa, SPXbb, SPXcc, and SPXdd.

During the first sub-period P4_1 of the fourth period P4, the disable third initialization signal GB1 may be supplied to the third initialization line IL31 positioned in the first block BL1. In addition, during the first sub-period P4_1, the enable emission control signal EM1 may be supplied to the emission control line EL1 positioned in the first block BL1.

When the disable third initialization signal GB1 is supplied to the third initialization line IL31, the thirteenth transistor T13 included in each of the sub-pixels SPXaa is turned off. When the enable emission control signal EM1 is supplied to the emission control line EL1, the fifth transistor T5, the sixth transistor T6, the eleventh transistor T11, and the twelfth transistor T12 included in each of the sub-pixels SPXaa may be turned on. At this time, the seventh transistor T7 included in each of the sub-pixels SPXaa may supply a constant driving current to the light emitting element LD correspondingly to the second data signal DS2.

Meanwhile, during the first sub-period P4_1, the sweep signal SWE1 is supplied to the sweep line SWL1 included in the first block BL1. The sweep signal SWE1 may be gradually decreased from the voltage of the reference power Vref to a voltage lower than the reference power Vref.

At this time, the voltage of the first node N1 included in each of the sub-pixels SPXaa gradually decreases due to coupling of the first capacitor C1 included in each of the sub-pixels SPXaa. As the voltage of the first data signal DS1 supplied in the second period P2 is increased, a time point when the first transistor T1 included in each of the sub-pixels SPXaa is turned on may be delayed. As the voltage of the first data signal DS1 supplied in the second period P2 is decreased, the time point when the first transistor T1 included in each of the sub-pixels SPXaa is turned on may be earlier.

In this case, a time point when each of the sub-pixels SPXaa included in the first block BL1 does not emit light may be set differently correspondingly to the first data signal DS1. When the first transistor T1 included in each of the sub-pixels SPXaa is turned on during the first sub-period P4_1, the voltage of the fourth node N4 included in each of the sub-pixels SPXaa may be set to the voltage of the first power VDDW, and thus the seventh transistor T7 included in each of the sub-pixels SPXaa is turned off.

When the seventh transistor T7 included in each of the sub-pixels SPXaa is turned off, the current path may be blocked, and thus supply of the driving current to the light emitting element LD included in each of the sub-pixels SPXaa may be stopped. Accordingly, the light emitting element LD may be set to the non-emission state. As a time point when the driving current is stopped is earlier, a luminance of the sub-pixel SPXaa visible during a corresponding frame period may be decreased. As the time point when the driving current is stopped is delayed, the luminance of the sub-pixel SPXaa visible during the corresponding frame period may be increased.

Meanwhile, in the first sub-period P4_1, as shown in FIGS. 12A and 12B, the sub-pixels SPXaa included in the first block BL1 may be set to the emission state, and the sub-pixels SPXbb, SPXcc, and SPXdd included in the second block BL2 to the fourth block BL4 may be set to the non-emission state.

During the second sub-period P4_2 of the fourth period P4, the disable third initialization signal GB2 may be supplied to the third initialization line IL32 positioned in the second block BL2. In addition, during the second sub-period P4_2, the enable emission control signal EM2 may be supplied to the emission control line EL2 positioned in the second block BL2.

When the disable third initialization signal GB2 is supplied to the third initialization line IL32, the thirteenth transistor T13 included in each of the sub-pixels SPXbb is turned off. When the enable emission control signal EM2 is supplied to the emission control line EL2, the fifth transistor T5, the sixth transistor T6, the eleventh transistor T11, and the twelfth transistor T12 included in each of the sub-pixels SPXbb may be turned on. At this time, the seventh transistor T7 included in each of the sub-pixels SPXbb may supply a constant driving current to the light emitting element LD correspondingly to the second data signal DS2.

Meanwhile, during the second sub-period P4_2, the sweep signal SWE2 is supplied to the sweep line SWL2 included in the second block BL2. The sweep signal SWE2 may be gradually decreased from the voltage of the reference power Vref to a voltage lower than the reference power Vref.

At this time, the voltage of the first node N1 included in each of the sub-pixels SPXbb gradually decreases due to coupling of the first capacitor C1 included in each of the sub-pixels SPXbb. As the voltage of the first data signal DS1 supplied in the second period P2 is increased, a time point when the first transistor T1 included in each of the sub-pixels SPXbb is turned on may be delayed. As the voltage of the first data signal DS1 supplied in the second period P2 is decreased, the time point when the first transistor T1 included in each of the sub-pixels SPXbb is turned on may be earlier.

In this case, a time point when each of the sub-pixels SPXbb included in the second block BL2 does not emit light may be set differently correspondingly to the first data signal DS1. When the first transistor T1 included in each of the sub-pixels SPXbb is turned on during the second sub-period P4_2, the voltage of the fourth node N4 included in each of the sub-pixels SPXbb may be set to the voltage of the first power VDDW, and thus the seventh transistor T7 included in each of the sub-pixels SPXbb is turned off.

When the seventh transistor T7 included in each of the sub-pixels SPXbb is turned off, the current path may be blocked, and thus supply of the driving current to the light emitting element LD included in each of the sub-pixels SPXbb may be stopped. Accordingly, the light emitting element LD may be set to the non-emission state. As a time point when the driving current is stopped is earlier, a luminance of the sub-pixel SPXbb visible during a corresponding frame period may be decreased. As the time point when the driving current is stopped is delayed, the luminance of the sub-pixel SPXbb visible during the corresponding frame period may be increased.

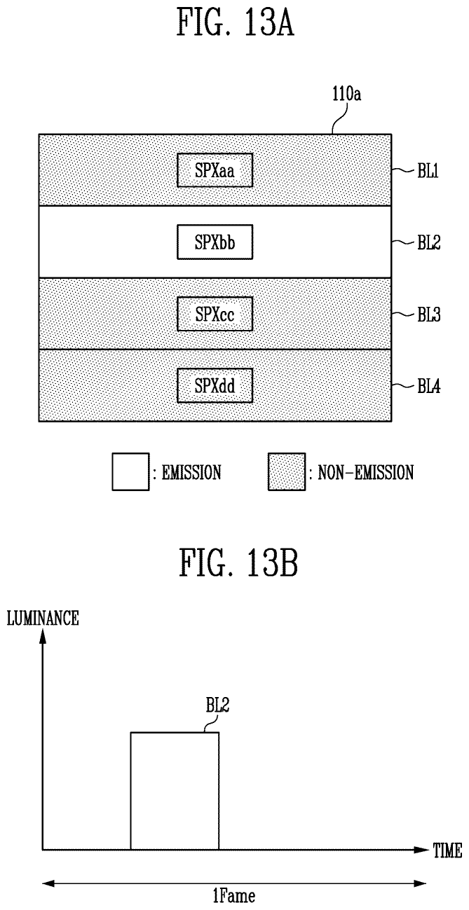

Meanwhile, in the second sub-period P4_2, as shown in FIGS. 13A and 13B, the sub-pixels SPXbb included in the second block BL2 may be set to the emission state, and the sub-pixels SPXaa, SPXcc, and SPXdd included in the first block BL1, the third block BL3, and the fourth block BL4 may be set to the non-emission state.

During the third sub-period P4_3 of the fourth period P4, the disable third initialization signal GB3 may be supplied to the third initialization line IL33 positioned in the third block BL3. In addition, during the third sub-period P4_3, the enable emission control signal EM3 may be supplied to the emission control line EL3 positioned in the third block BL3.

When the disable third initialization signal GB3 is supplied to the third initialization line IL33, the thirteenth transistor T13 included in each of the sub-pixels SPXcc is turned off. When the enable emission control signal EM3 is supplied to the emission control line EL3, the fifth transistor T5, the sixth transistor T6, the eleventh transistor T11, and the twelfth transistor T12 included in each of the sub-pixels SPXcc may be turned on. At this time, the seventh transistor T7 included in each of the sub-pixels SPXcc may supply a driving current corresponding to a constant current to the light emitting element LD correspondingly to the second data signal DS2.

Meanwhile, during the third sub-period P4_3, the sweep signal SWE3 is supplied to the sweep line SWL3 included in the third block BL3. The sweep signal SWE3 may gradually decrease from the voltage of the reference power Vref to a voltage lower than the reference power Vref.

At this time, the voltage of the first node N1 included in each of the sub-pixels SPXcc gradually decreases due to coupling of the first capacitor C1 included in each of the sub-pixels SPXcc. As the voltage of the first data signal DS1 supplied in the second period P2 is increased, a time point when the first transistor T1 included in each of the sub-pixels SPXcc is turned on may be delayed. As the voltage of the first data signal DS1 supplied in the second period P2 is decreased, the time point when the first transistor T1 included in each of the sub-pixels SPXcc is turned on may be earlier.

In this case, a time point when each of the sub-pixels SPXcc included in the third block BL3 does not emit light may be set differently correspondingly to the first data signal DS1. When the first transistor T1 included in each of the sub-pixels SPXcc is turned on during the third sub-period P4_3, the voltage of the fourth node N4 included in each of the sub-pixels SPXcc may be set to the voltage of the first power VDDW, and thus the seventh transistor T7 included in each of the sub-pixels SPXcc is turned off.

When the seventh transistor T7 included in each of the sub-pixels SPXcc is turned off, the current path may be blocked, and thus supply of the driving current to the light emitting element LD included in each of the sub-pixels SPXcc may be stopped. Accordingly, the light emitting element LD may be set to the non-emission state. As a time point when the driving current is stopped is earlier, a luminance of the sub-pixel SPXcc visible during a corresponding frame period may be decreased. As the time point when the driving current is stopped is delayed, the luminance of the sub-pixel SPXcc visible during the corresponding frame period may be increased.

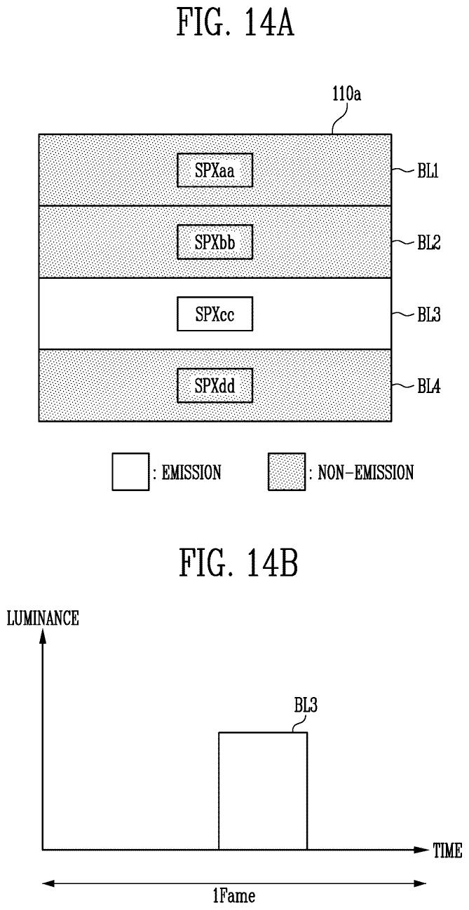

Meanwhile, in the third sub-period P4_3, as shown in FIGS. 14A and 14B, the sub-pixels SPXcc included in the third block BL3 may be set to the emission state, and the sub-pixels SPXaa, SPXbb, and SPXdd included in the first block BL1, the second block BL2, and the fourth block BL4 may be set to the non-emission state.

During the fourth sub-period P4_4 of the fourth period P4, the disable third initialization signal GB4 may be supplied to the third initialization line IL34 positioned in the fourth block BL4. In addition, during the fourth sub-period P4_4, the enable emission control signal EM4 may be supplied to the emission control line EL4 positioned in the fourth block BL4.

When the disable third initialization signal GB4 is supplied to the third initialization line IL34, the thirteenth transistor T13 included in each of the sub-pixels SPXdd is turned off. When the enable emission control signal EM4 is supplied to the emission control line EL4, the fifth transistor T5, the sixth transistor T6, the eleventh transistor T11, and the twelfth transistor T12 included in each of the sub-pixels SPXdd may be turned on. At this time, the seventh transistor T7 included in each of the sub-pixels SPXdd may supply a driving current corresponding to a constant current to the light emitting element LD correspondingly to the second data signal DS2.

Meanwhile, during the fourth sub-period P4_4, the sweep signal SWE4 is supplied to the sweep line SWL4 included in the fourth block BL4. The sweep signal SWE4 may be gradually decreased from the voltage of the reference power Vref to a voltage lower than the reference power Vref.

At this time, the voltage of the first node N1 included in each of the sub-pixels SPXbb gradually decreases due to coupling of the first capacitor C1 included in each of the sub-pixels SPXdd. As the voltage of the first data signal DS1 supplied in the fourth period P4 is increased, a time point when the first transistor T1 included in each of the sub-pixels SPXdd is turned on may be delayed. As the voltage of the first data signal DS1 supplied in the fourth period P4 is decreased, the time point when the first transistor T1 included in each of the sub-pixels SPXdd is turned on may be earlier.

In this case, a time point when each of the sub-pixels SPXdd included in the fourth block BL4 does not emit light may be set differently correspondingly to the first data signal DS1. When the first transistor T1 included in each of the sub-pixels SPXdd is turned on during the fourth sub-period P4_4, the voltage of the fourth node N4 included in each of the sub-pixels SPXdd may be set to the voltage of the first power VDDW, and thus the seventh transistor T7 included in each of the sub-pixels SPXdd is turned off.

When the seventh transistor T7 included in each of the sub-pixels SPXdd is turned off, the current path may be blocked, and thus supply of the driving current to the light emitting element LD included in each of the sub-pixels SPXdd may be stopped. Accordingly, the light emitting element LD may be set to the non-emission state. As a time point when the driving current is stopped is earlier, a luminance of the sub-pixel SPXdd visible during a corresponding frame period may be decreased. As the time point when the driving current is stopped is delayed, the luminance of the sub-pixel SPXdd visible during the corresponding frame period may be increased.

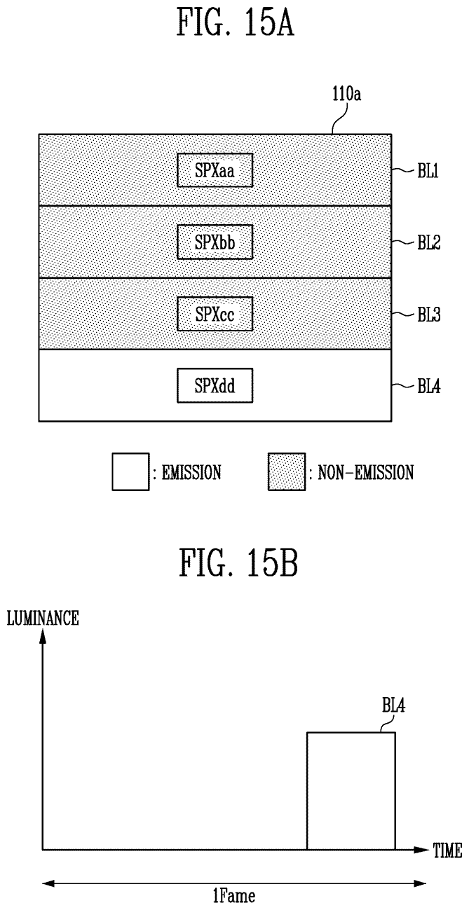

Meanwhile, in the fourth sub-period P4_4, as shown in FIGS. 15A and 15B, the sub-pixels SPXdd included in the fourth block BL4 may be set to the emission state, and the sub-pixels SPXaa, SPXbb, and SPXcc included in the first block BL1 to the third block BL3 may be set to the non-emission state.

As described above, according to some embodiments of the present disclosure, the display unit 110a may be divided into the plurality of blocks, and the sub-pixels SPXaa, SPXbb, SPXcc, and SPXdd included in the blocks BL1 to BL4 may emit light at different times. For example, when the display unit 110a includes four blocks, each of the sub-pixels SPXaa, SPXbb, SPXcc, and SPXdd may emit light during 25% (or approximately 25%) of one frame period. For example, when the display unit 110a includes j blocks, the fourth period P4 may include j sub-periods. In addition, the sub-pixels included in each of the j blocks may emit light during 1/j period (or approximately 1/j period) during one frame period.

As described above, when the sub-pixels included in the display unit 110a emit light at different times in a block unit, the voltage drop (IR-drop) of the power VDDA may be minimized or reduced, and thus display quality may be relatively improved.

Additionally, display quality may be relatively improved when the fourth period P4 is divided into the first sub-period P4_1, the second sub-period P4_2, the third sub-period P4_3, and the fourth sub-period P4_4. That is, when the fourth period P4 is divided into the first sub-period P4_1, the second sub-period P4_2, the third sub-period P4_3, and the fourth sub-period P4_4 and driven, the slope of the sweep signal SWE may be increased. When the slope of the sweep signal SWE is increased, the voltage of the fourth node N4 may be quickly increased to the first power VDDW due to the turn-on of the first transistor T1, and thus the unintended driving current being supplied to the light emitting element LD may be prevented or reduced.

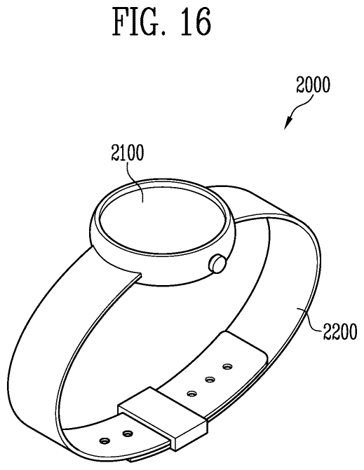

FIGS. 16 to 19 are perspective views illustrating application examples of a display device according to some embodiments of the present disclosure.

Referring to FIG. 16, the display device 100 according to some embodiments of the present disclosure may be applied to a smart watch 2000 including a display unit 2100 and a strap unit 2200.

The smart watch 2000 may be a wearable electronic device. For example, the smart watch 2000 may have a structure in which the strap unit 2200 is mounted on a user's wrist. Here, the display device 100 (or the display units 110 and 110a) may be applied to the display unit 2100, and image data including time information may be provided to a user.

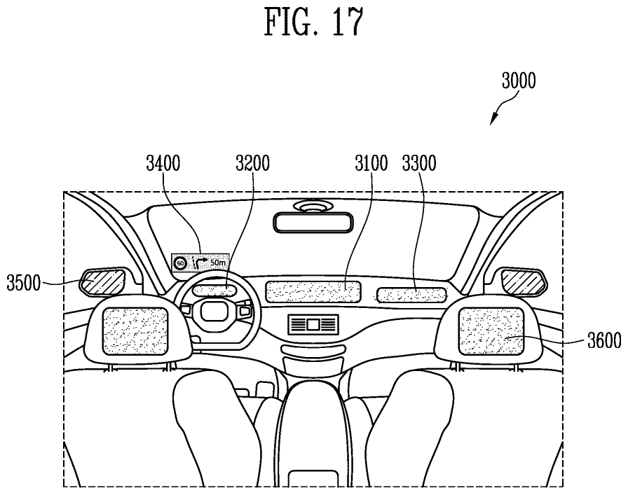

Referring to FIG. 17, the display device 100 according to some embodiments of the present disclosure may be applied to an automotive display system 3000. Here, the automotive display system 3000 may include a computing system provided inside and/or outside a vehicle to provide image data.

For example, the display device 100 may be applied to at least one of an infotainment panel 3100, a cluster 3200, a co-driver display 3300, a head-up display 3400, a side mirror display 3500, and a rear seat displays 3600 provided in a vehicle.

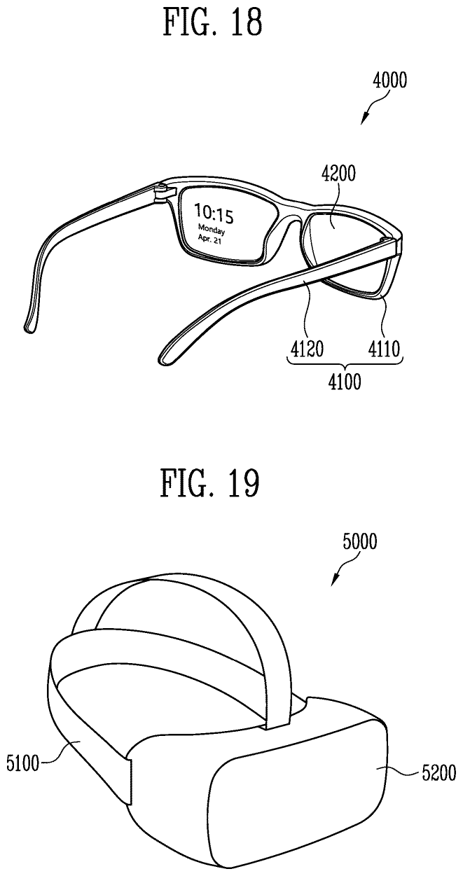

Referring to FIG. 18, the display device 100 according to some embodiments of the present disclosure may be applied to smart glasses 4000. The smart glasses 4000 may be a wearable electronic device that may be worn on a user's head. For example, the smart glasses 4000 may be a wearable device for augmented reality.

The smart glasses 4000 may include a frame 4100 and a lens unit 4200. The frame 4100 may include a housing 4110 that supports the lens unit 4200 and a leg unit 4120 for the user to wear. The leg unit 4120 may be connected to the housing 4110 through a hinge and may be folded or unfolded relative to the housing 4110.

A battery, a touch pad, a microphone, a camera, and the like may be built in the frame 4100. In addition, a projector that outputs light, a processor that controls a light signal, and the like may be built in the frame 4100.

The lens unit 4200 may include an optical member that transmits or reflects light. For example, the lens unit 4200 may include glass, transparent synthetic resin, or the like.

In order for user's eyes to recognize visual information, the lens unit 4200 may reflect an image by the light signal transmitted from the projector of the frame 4100 by a rear surface (for example, a surface of a direction facing the user's eyes) of the lens unit 4200. For example, the user may recognize visual information such as time and date displayed on the lens unit 4200. At this time, the projector and/or the lens unit 4200 may be a type of display device. The display device 1200 may be applied to the projector and/or the lens unit 4200.

Referring to FIG. 19, the display device 100 according to some embodiments of the present disclosure may be applied to a head mounted display device 5000.

The head mounted display device 5000 may be a wearable electronic device that may be worn on a user's head. For example, the head mounted display device 5000 may be a wearable device for virtual reality or mixed reality.

The head mounted display device 5000 may include a head mount band 5100 and a display device receiving case 5200. The head mount band 5100 may be connected to the display device receiving case 5200. The head mount band 5100 may include a horizontal band and/or a vertical band for fixing the head mounted display device 5000 to a user's head. The horizontal band may be configured to surround a side portion of the user's head, and the vertical band may be configured to surround an upper portion of the user's head. However, embodiments are not limited thereto. For example, the head mount band 5100 may be implemented in a form of a glasses frame, a helmet, or the like.

The display device receiving case 5200 may receive the display device 100.

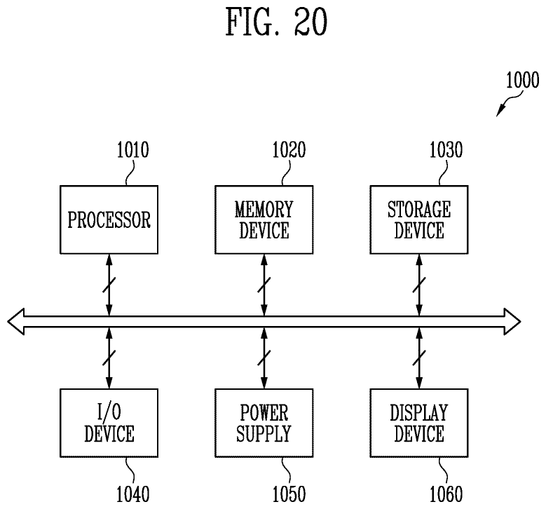

FIG. 20 is a schematic block diagram illustrating an electronic device 1000 including a display device in accordance with an embodiment.

Referring to FIGS. 20, the electronic device 1000 may include a processor 1010, a memory device 1020, a storage device 1030, an input/output (I/O) device 1040, a power supply 1050, and a display device 1060. The display device 1060 may be the display device 100. The electronic device 1000 may further include various ports for communication with a video card, a sound card, a memory card, a USB device, or other systems.

For example, the electronic device 1000 may be a cellular phone, a video phone, a smart pad, a smartwatch, a navigation device for vehicles, a computer monitor, a laptop computer, a head-mounted display device, or the like.

The processor 1010 may perform specific calculations or tasks. In an embodiment, the processor 1010 may include at least one of a central processing unit, an application processor, a graphic processing unit, a communication processor, an image signal processor, a controller, or the like. The processor 1010 may be connected to other components through an address bus, a control bus, a data bus, and the like. In an embodiment, the processor 1010 may be connected to an expansion bus such as a peripheral component interconnect (PCI) bus. In an embodiment, the processor 1010 may provide input image data to the display device 1060. Hence, the display device 1060 may display an image based on the input image data provided from the processor 1010.

The memory device 1020 may store data needed to perform the operation of the electronic device 1000. The memory device 1020 may function as a working memory and/or a buffer memory for the processor 1010. For example, the memory device 1020 may include one or more volatile memory devices such as a dynamic random access memory (DRAM) device, a static random access memory (SRAM) device, and a mobile DRAM device.

The storage device 1030 may store data in response to control signals or data from the processor 1010. The storage device 1030 may include one or more non-volatile storages to retain the data even when the electronic device 1000 is powered off. In some embodiments, the storage device 1030 may include a solid state drive (SSD), a hard disk drive (HDD), a CD-ROM, or the like.

The I/O device 1040 may include input devices such as a keyboard, a keypad, a touchpad, a touch screen, and a mouse, and output devices such as a speaker and a printer. In an embodiment, the display device 1060 may be integrated with the I/O device 1040.

The power supply 1050 may supply power needed to perform the operation of the electronic device 1000. For example, the power supply 1050 may include a power management integrated circuit (PMIC). In an embodiment, the power supply 1050 may supply power to the display device 1060.

The display device 1060 may display images in response to image data signals and/or control signals from the processor 1010. The display device 1060 may be connected to other components through the buses or other communication links.

Although the above has been described with reference to the embodiments of the disclosure, those skilled in the art will understand that the disclosure may be variously modified and changed without departing from the spirit and scope of the disclosure described in the appended claims, and their equivalents.

What is claimed is:

1. A display device comprising:
sub-pixels including a first circuit unit configured to control a supply period of a driving current correspondingly to a first data signal, and a second circuit unit configured to supply the driving current to a light emitting element correspondingly to a second data signal; and
a display unit partitioned into j (j is a natural number of 2 or more) blocks including two or more of the sub-pixels,
wherein the sub-pixels included in different blocks are configured to emit light at different times.

2. The display device according to claim 1, wherein the sub-pixels are configured to be driven in periods divided into an initialization period, a first data signal writing period, a second data signal writing period, and an emission period, and
the emission period includes j sub-periods.

3. The display device according to claim 1, wherein sub-pixels included in a first block among the j blocks are configured to emit light in a first sub-period, and sub-pixels included in a j-th block are configured to emit light in a j-th sub-period that does not overlap the first sub-period.

4. The display device according to claim 1, wherein a voltage of the first data signal is set correspondingly to a grayscale to be expressed.

5. The display device according to claim 1, wherein the second data signal of a same voltage is supplied to the sub-pixels.

6. The display device according to claim 1, wherein the sub-pixels include a first sub-pixel configured to emit light of a first color, a second sub-pixel configured to emit light of a second color, and a third sub-pixel configured to emit light of a third color, and
a voltage of the second data signal is different in the first sub-pixel, the second sub-pixel, and the third sub-pixel.

7. The display device according to claim 1, wherein the first circuit unit comprises:
a first transistor having a gate electrode connected to a first node, a first electrode connected to a second node, and a second electrode connected to a third node;
a second transistor connected between a data line and the second node, and having a gate electrode connected to a first scan line;
a third transistor connected between the first node and the third node and having a gate electrode connected to the first scan line;
a fourth transistor connected between the first node and a fourth power line, and having a gate electrode connected to a first initialization line;
a fifth transistor connected between a first power line and the second node, and having a gate electrode connected to an emission control line;
a sixth transistor connected between the third node and a fourth node, and having a gate electrode connected to the emission control line; and
a first capacitor connected between a sweep line and the first node.

8. The display device according to claim 7, wherein the first transistor, the fifth transistor, and the sixth transistor are P-type transistors, and
the second transistor, the third transistor, and the fourth transistor are N-type transistors.

9. The display device according to claim 7, wherein the first transistor has an auxiliary gate electrode connected to the first power line,
each of the second transistor and the third transistor has an auxiliary gate electrode connected to the first scan line, and
the fourth transistor has an auxiliary gate electrode connected to the first initialization line.

10. The display device according to claim 7, wherein the second circuit unit comprises:
a seventh transistor having a gate electrode connected to the fourth node, a first electrode connected to a fifth node, and a second electrode connected to a sixth node;
an eighth transistor connected between the data line and the fifth node, and having a gate electrode connected to a second scan line;
a ninth transistor connected between the fourth node and the sixth node, and having a gate electrode connected to the second scan line;
a tenth transistor connected between the fourth node and the fourth power line, and having a gate electrode connected to a second initialization line;
an eleventh transistor connected between a second power line and the fifth node, and having a gate electrode connected to the emission control line;
a twelfth transistor connected between the sixth node and a first electrode of the light emitting element, and having a gate electrode connected to the emission control line;
a thirteenth transistor connected between the first electrode of the light emitting element and a fifth power line, and having a gate electrode connected to a third initialization line;
the light emitting element connected between the twelfth transistor and a third power line; and
a second capacitor connected between the second power line and the fourth node.

11. The display device according to claim 10, wherein the seventh transistor, the eleventh transistor, the twelfth transistor, and the thirteenth transistor are P-type transistors, and
the eighth transistor, the ninth transistor, and the tenth transistor are N-type transistors.

12. The display device according to claim 10, wherein the seventh transistor has an auxiliary gate electrode connected to the second power line,
each of the eighth transistor and the ninth transistor has an auxiliary gate electrode connected to the second scan line, and
the tenth transistor has an auxiliary gate electrode connected to the second initialization line.

13. The display device according to claim 10, wherein the second scan line, the first initialization line, and the second initialization line are commonly connected to the sub-pixels.

14. The display device according to claim 10, wherein the first scan line includes a plurality of first scan lines, and the plurality of first scan lines are connected to the sub-pixels in a horizontal line unit.

15. The display device according to claim 10, wherein the emission control line includes a plurality of emission control lines positioned in each block, the sub-pixels positioned in different blocks are electrically connected to different emission control lines,
the sweep line includes a plurality of sweep lines positioned in each block, the sub-pixels positioned in different blocks are electrically connected to different sweep lines,
the third initialization line includes a plurality of third initialization lines positioned in each block, and the sub-pixels positioned in different blocks are electrically connected to different third initialization lines.

16. The display device according to claim 10, further comprising:
a first scan driver configured to supply a first scan signal to the first scan line;
an emission driver configured to supply an emission control signal to the emission control line;
a sweep driver configured to supply a reference voltage and a sweep signal to the sweep line;
a third initialization driver configured to supply a third initialization signal to the third initialization line; and
a timing controller configured to control the first scan driver, the emission driver, the sweep driver, and the third initialization driver.

17. The display device according to claim 16, wherein the timing controller is configured to supply a second scan signal to the second scan line, a first initialization signal to the first initialization line, and a second initialization signal to the second initialization line.

18. The display device according to claim 16, further comprising:
a second scan driver configured to supply a second scan signal to the second scan line;
a first initialization driver configured to supply a first initialization signal to the first initialization line; and
a second initialization driver configured to supply a second initialization signal to the second initialization line.

19. A display device comprising:
a display unit partitioned into a plurality of blocks including two or more sub-pixels,
wherein sub-pixels included in different blocks are configured to emit light at different times during one frame period.

20. A method of driving a display device, the method comprising:
initializing sub-pixels included in a first block and a second block;
supplying a first data signal corresponding to an emission time while sequentially selecting the sub-pixels included in the first block and the second block;
simultaneously supplying a second data signal corresponding to a driving current to the sub-pixels included in the first block and the second block;
emitting light by the sub-pixels included in the first block during a first period of one frame period; and
emitting light by the sub-pixels included in the second block during a second period that does not overlap the first period of the one frame period.

21. An electronic device, comprising:
a processor to provide input image data;
a display device to display an image based on the input image data; and
wherein the display device comprising:
sub-pixels including a first circuit unit configured to control a supply period of a driving current correspondingly to a first data signal, and a second circuit unit configured to supply the driving current to a light emitting element correspondingly to a second data signal; and
a display unit partitioned into j (j is a natural number of 2 or more) blocks including two or more of the sub-pixels,
wherein the sub-pixels included in different blocks are configured to emit light at different times.
